(19) United States
(12) Patent Application Publication
(10) Pub. No.: US 2026/0001548 A1
(43) Pub. Date: Jan. 1, 2026

(54) VEHICLE CONTROL DEVICE, CONTROL METHOD, AND STORAGE MEDIUM

(71) Applicant: HONDA MOTOR CO., LTD., Tokyo (JP)

(72) Inventors: Takahiro FUJITA, Tokyo (JP); Yuki KIZUMI, Tokyo (JP); Ryo USHIKI, Tokyo (JP)

(73) Assignee: HONDA MOTOR CO., LTD., Tokyo (JP)

(21) Appl. No.: 19/250,106

(22) Filed: Jun. 26, 2025

(30) Foreign Application Priority Data
Jun. 26, 2024 (JP) 2024-102737

(51) Int. Cl. B60W 30/18

(52) U.S. Cl. CPC B60W 30/18159; B60W 2552/10; B60W 2552/53; B60W 2556/40

(57) ABSTRACT

A vehicle control device includes a trajectory generation unit configured to, in a case where the intersection is a multi-way intersection, and an intersection angle between a first road including the entry position and a second road including the exit position is within a first angle range including 180 degrees, specify, based on a recognition result, a first reference point which is an end point of a boundary between the first road and the intersection on one side in a width direction of the first road, and a second reference point which is an end point of a boundary between the second road and the intersection on one side in a width direction of the second road, derive, based on the first and second reference point, a first reference line passing through the first and second reference point, and generate the travel trajectory based on the first reference line.

This application is based upon and claims the benefit of priority from prior Japanese patent application No. 2024-102737, filed on Jun. 26, 2024, the entire contents of which are incorporated herein by reference.

### TECHNICAL FIELD

The present disclosure relates to a vehicle control device, control method, and a storage medium storing a control program.

### BACKGROUND ART

In recent years, active efforts have been made to provide access to a sustainable transportation system in consideration of vulnerable traffic participants. As one of these efforts, research and development on driving assistance techniques and autonomous driving techniques for vehicles such as automobiles have been made in order to further improve safety and convenience of traffic.

As an example of the driving assist technique, JP2023-160381A discloses a technique of: acquiring intersection information that is information related to an intersection that a host vehicle is about to enter; based on the intersection information, acquiring data indicating a position and direction of each of a plurality of arrow markings in front of the intersection; calculating a distance in a lane width direction to each of the plurality of road arrow markings from a travel track of a vehicle traveling through the intersection; determining a destination of a travel track of the host vehicle based on a direction of a reference road arrow marking that is one of the road arrow markings whose distance is less than a first threshold; generating data indicating a duplicated travel track obtained by duplicating the travel track to be translated to a position of a road arrow marking that indicates the same direction as the destination of the travel track and is different from the reference road arrow marking; and estimating a shape of a traveling lane in the intersection based on the data indicating the duplicated travel track.

### SUMMARY OF INVENTION

However, in the related art described above, it is required to prepare information on the intersection in advance, making it difficult for the vehicle to appropriately travel through the intersection with a simple configuration without requiring such information.

Aspects of the present disclosure relate to a vehicle control device, a control method, and a storage medium storing a control program that enable a vehicle to appropriately travel through an intersection with a simple configuration.

According to another aspect of the present disclosure, there is provided a vehicle control device for controlling a vehicle, including:
a recognition unit configured to recognize a surrounding situation of the vehicle;
a trajectory generation unit configured to generate, in response to an intersection present in a traveling direction of the vehicle being recognized by the recognition unit, a travel trajectory from an entry position to an exit position of the vehicle at the intersection; and
a travel control unit configured to cause the vehicle to travel based on the travel trajectory generated by the trajectory generation unit, in which
the trajectory generation unit is configured to, in a case where the intersection is a multi-way intersection at which five or more roads or more are connected, and an intersection angle at the intersection between a first road including the entry position and a second road including the exit position is within a first angle range including 180 degrees,
   specify, based on a recognition result of the recognition unit, a first reference point which is an end point of a boundary between the first road and the intersection on one side in a width direction of the first road, and a second reference point which is an end point of a boundary between the second road and the intersection on one side in a width direction of the second road,
   derive, based on the first reference point and the second reference point, a first reference line which is a line segment passing through the first reference point and the second reference point, and
   generate the travel trajectory based on the first reference line.

According to another aspect of the present disclosure, there is provided a control method including causing a computer, for controlling a vehicle, to perform processing including:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, in which
in the generating of the travel trajectory, in a case where the intersection is a multi-way intersection at which five or more roads are connected, and an intersection angle at the intersection between a first road including the entry position and a second road including the exit position is within a first angle range including 180 degrees,
   based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified,
   based on the first reference point and the second reference point, a first reference line which is a line segment passing through the first reference point and the second reference point is derived, and
   the travel trajectory is generated based on the first reference line.

According to another aspect of the present disclosure, there is provided a non-transitory computer-readable storage medium storing a control program causing a computer, for controlling a vehicle, to execute processing including:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, in which
in the generating of the travel trajectory, in a case where the intersection is a multi-way intersection at which five or more roads are connected, and an intersection angle at the intersection between a first road including the entry position and a second road including the exit position is within a first angle range including 180 degrees,
   based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified,
   based on the first reference point and the second reference point, a first reference line which is a line segment passing through the first reference point and the second reference point is derived, and
   the travel trajectory is generated based on the first reference line.

According to aspects of the present disclosure, it is possible to provide a vehicle control device, a control method, and a control program that enable a vehicle to appropriately travel through an intersection with a simple configuration, thereby improving safety of traffic and contributing to development of a sustainable transportation system.

According to another aspect of the present disclosure, there is provided a vehicle control device for controlling a vehicle, the vehicle control device including:
a recognition unit configured to recognize a surrounding situation of the vehicle;
a trajectory generation unit configured to generate, in response to an intersection present in a traveling direction of the vehicle being recognized by the recognition unit, a travel trajectory from an entry position to an exit position of the vehicle at the intersection; and
a travel control unit configured to cause the vehicle to travel based on the travel trajectory generated by the trajectory generation unit, in which
the trajectory generation unit is configured to,
in a case where the intersection is a multi-way intersection at which five or more roads are connected, and the vehicle straight travels through the intersection from a first road including the entry position to a second road including the exit position,
derive, based on a recognition result of the recognition unit, an entry direction line which is a line segment passing through the entry position and extending along the first road, and an exit direction line which is a line segment passing through the exit position and extending along the second road,
derive, based on the entry position, the exit position, the entry direction line, and the exit direction line, a reference circle having the entry direction line and the exit direction line as tangents and having the entry position and the exit position as points of tangency, and
generate an arc of the reference circle between the entry position and the exit position as the travel trajectory.

According to another aspect of the present disclosure, there is provided a control method including causing a computer, for controlling a vehicle, to perform processing including:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, in which
in the generating of the travel trajectory,
in a case where the intersection is a multi-way intersection at which five or more roads are connected, and the vehicle straight travels through the intersection from a first road including the entry position to a second road including the exit position,
based on a recognition result of the surrounding situation, an entry direction line which is a line segment passing through the entry position and extending along the first road, and an exit direction line which is a line segment passing through the exit position and extending along the second road are derived,
based on the entry position, the exit position, the entry direction line, and the exit direction line, a reference circle having the entry direction line and the exit direction line as tangents and having the entry position and the exit position as points of tangency is derived, and
an arc of the reference circle between the entry position and the exit position is generated as the travel trajectory.

According to another aspect of the present disclosure, there is provided a non-transitory computer-readable storage medium storing a control program causing a computer, for controlling a vehicle, to execute processing including:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, in which
in the generating of the travel trajectory,
   in a case where the intersection is a multi-way intersection at which five or more roads are connected, and the vehicle straight travels through the intersection from a first road including the entry position to a second road including the exit position,
   based on a recognition result of the surrounding situation, an entry direction line which is a line segment passing through the entry position and extending along the first road, and an exit direction line which is a line segment passing through the exit position and extending along the second road are derived,
   based on the entry position, the exit position, the entry direction line, and the exit direction line, a reference circle having the entry direction line and the exit direction line as tangents and having the entry position and the exit position as points of tangency is derived, and
   an arc of the reference circle between the entry position and the exit position is generated as the travel trajectory.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 including a control device 30 that is an embodiment of a vehicle control device of the present disclosure;

FIG. 2 is a diagram showing an example of a situation assumed in the present embodiment.

FIG. 3 is a diagram showing an example of a travel trajectory generated when the vehicle 1 travels through an intersection CP from a road Rd1 to a road Rd3;

FIG. 4 is a diagram showing an example of a travel trajectory generated when the vehicle 1 travels through the intersection CP from the road Rd1 to a road Rd2;

FIG. 5 is a diagram showing an example of a travel trajectory generated when the vehicle 1 travels through the intersection CP from the road Rd1 to a road Rd4;

FIG. 6 is a diagram showing an example of a travel trajectory generated when the vehicle 1 travels through the intersection CP from the road Rd1 to a road Rd5;

FIG. 7 is a flowchart (Flowchart 1 among Flowcharts 1 to 3) showing an example of a processing procedure performed by the control device 30;

FIG. 8 is a flowchart (Flowchart 2 among Flowcharts 1 to 3) showing an example of the processing procedure by the control device 30;

FIG. 9 is a flowchart (Flowchart 3 among Flowcharts 1 to 3) showing an example of the processing procedure performed by the control device 30;

FIG. 10 is a diagram showing a modification (Modification 1) of the travel trajectory generated when the vehicle 1 travels straight through the intersection CP;

FIG. 11 is a diagram showing a modification (Modification 2) of the travel trajectory generated when the vehicle 1 travels straight through the intersection CP;

FIG. 12 is a diagram showing a modification of the travel trajectory generated when the vehicle 1 turns right at the intersection CP;

FIG. 13 is a diagram showing a modification of the travel trajectory generated when the vehicle 1 turns left at the intersection CP;

FIG. 14 is a diagram showing another modification of the travel trajectory generated when the vehicle 1 travels straight through the intersection CP; and

FIG. 15 is a flowchart showing another example of the processing procedure of straight travel processing in step Sp3 performed by the control device 30.

### DESCRIPTION OF EMBODIMENTS

Hereinafter, an embodiment of a vehicle control device, a control method, and a storage medium storing a control program according to the present disclosure will be described with reference to the drawings. The drawings are viewed in directions of reference signs. The following embodiment does not limit the present disclosure, and not all of elements described in the following embodiment are necessary to the present disclosure. Further, two or more elements described in the following embodiment may be freely combined without departing from the gist of the present disclosure. In the following description, the same or similar elements are denoted by the same or similar reference signs, and a description thereof may be omitted or simplified.

In the present description and the like, in order to simplify and clarify the description, front-rear (including near-far), left-right, and upper-lower directions are described according to directions seen from a driver who is an occupant of a vehicle (a vehicle 1 to be described later), and in the drawings, a front side of the vehicle is denoted by Fr, a rear side is denoted by Rr, a left side is denoted by L, and a right side is denoted by R.

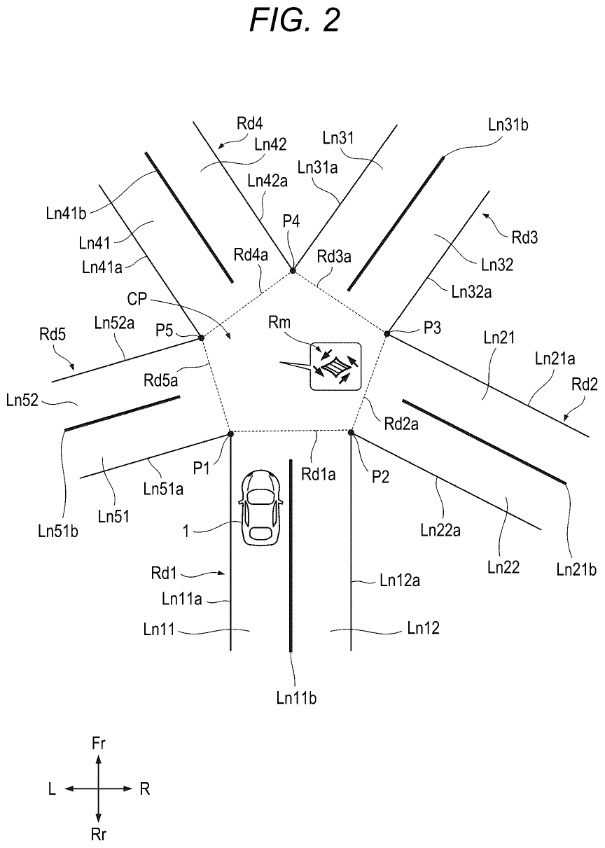

In the following embodiment, an example in which a left-hand traffic area such as Japan is assumed will be described, but the present disclosure is not limited thereto. For example, in a case where the present disclosure is applied to a right-hand traffic area such as the United States of America or the Republic of Chinese, the drawings such as FIGS. 2 to 6 and FIGS. 10 to 13 may be seen left-right reversed, and in the following description, “turn right” may be interpreted as “turn left” and “turn left” may be interpreted as “turn right”.

### 1. Vehicle

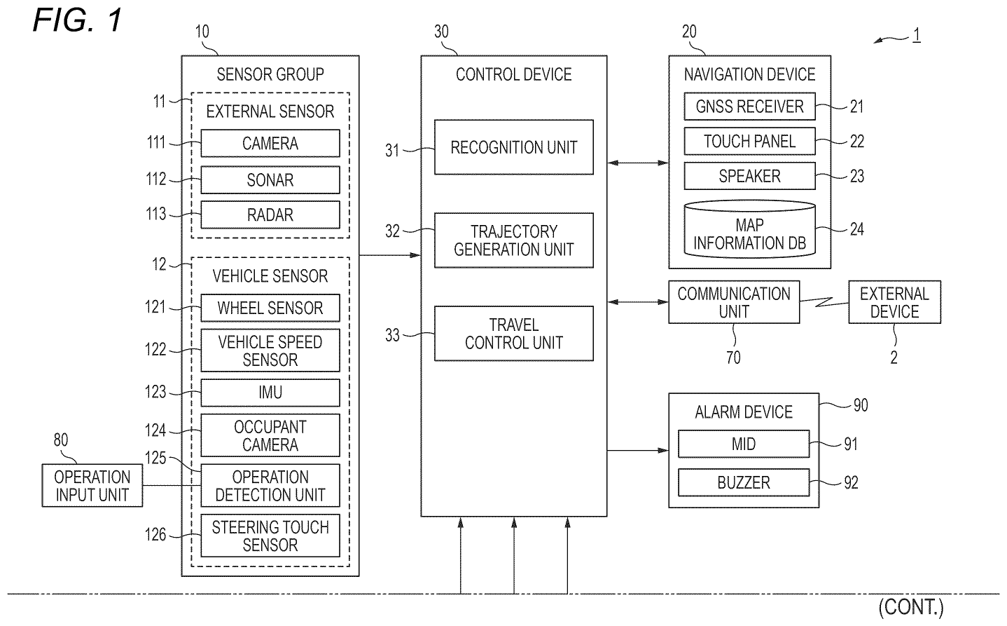

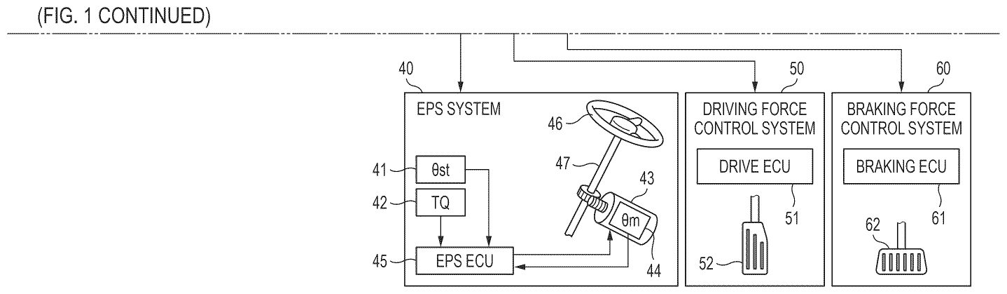

FIG. 1 is a block diagram showing a schematic configuration of the vehicle 1 including a control device 30 that is an embodiment of the vehicle control device of the present disclosure. The vehicle 1 according to the present embodiment shown in FIG. 1 is an automobile including a drive source (not shown), and wheels (not shown) including drive wheels driven by power of the drive source and steered wheels that are steerable. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 includes a sensor group 10, a navigation device 20, a control device 30 that is an example of the vehicle control device of the present disclosure, an electric power steering (EPS) system 40, a driving force control system 50, a braking force control system 60, a communication unit 70, an operation input unit 80, and an alarm device 90.

The sensor group 10 includes an external sensor 11 that acquires information on surroundings of the vehicle 1 (hereinafter also referred to as “peripheral information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external sensor 11 includes, for example, a camera 111, a sonar 112, and a radar 113. The camera 111 is an imaging device that images the surroundings of the vehicle 1 including a front side of the vehicle 1 and outputs image data of the obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to the surroundings of the vehicle 1 (for example, the front side, a rear side, and lateral sides of the vehicle 1), and receives reflected sounds from an object present in the surroundings of the vehicle 1, thereby detecting a distance to the object, a direction of the object, and the like. The radar 113 emits radio waves to the surroundings of the vehicle 1 including the front side of the vehicle 1, and receives reflected waves from an object present in the surroundings of the vehicle 1, thereby detecting a distance to the object, a direction of the object, and the like. As the radar 113, for example, a millimeter wave radar can be adopted.

The external sensor 11 may include light detection and ranging (LiDAR) instead of or in addition to the sonar 112 and the radar 113. In this case, the LiDAR emits laser light to the surroundings of the vehicle 1 including the front side of the vehicle 1, and receives reflected light from an object present in the surroundings of the vehicle 1, thereby detecting a distance to the object, a direction of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of the obtained interior image to the control device 30. For example, the occupant camera 124 can be a so-called “driver monitor camera” that is provided to be able to image a head of an occupant (hereinafter, referred to as a “driver”) sitting in a driver seat of the vehicle 1 from the front (in other words, be able to image a face). As the occupant camera 124, a digital camera using an imaging element such as the CCD or the CMOS can be adopted, similarly to the camera 111.

The operation detection unit 125 detects an operation performed by using the operation input unit 80 that is operable by the driver. In the present embodiment, the operation input unit 80 can include, for example, an operation button for receiving an operation to switch between on (in other words, operation) and off (in other words, non-operation) of predetermined driving assist control such as steering control performed by a travel control unit 33 to be described later. In this case, the operation detection unit 125 can detect an operation of turning on or off the predetermined driving assist control.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 as an example of map information and the like.

The map information database 24 includes road network information. The road network information is information representing roads based on a combination of nodes and links connecting the nodes (also referred to as “paths”). Each of the nodes in the road network information represents, for example, a feature of the road such as an intersection, a corner, or a dead end. In the road network information, for each of the nodes, for example, information indicating a location corresponding to the node (for example, coordinates that enable specifying of one location on a map such as latitude and longitude) is set. Further, in the road network information, for each of the links, information indicating nodes at both ends of the link, a road corresponding to the link, a link length, a lane number, a traveling direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire the detection result of the vehicle sensor 12 (for example, the wheel sensor 121 or the vehicle speed sensor 122) via the control device 30, and specify or complement the current position of the vehicle 1 by an inertial navigation system (INS) using the detection value of the vehicle sensor 12.

The touch panel 22 is implemented by combining a display device such as a liquid crystal display or an organic light emitting diode (OLED) with a pointing device (for example, a touch pad). The speaker 23 is configured to output sound to an occupant (for example, the driver) of the vehicle 1.

For example, the navigation device 20 searches for, by referring to the map information database 24, a route from the current position of the vehicle 1 to a destination set by the driver using the touch panel 22. Then, the navigation device 20 performs route guidance using the touch panel 22 and the speaker 23 based on the route searched for. Further, the navigation device 20 may cause the touch panel 22 to perform a predetermined display according to an instruction from the control device 30. Further, the navigation device 20 may output, to the control device 30, information indicating the specified current position of the vehicle 1 or predetermined information (for example, information indicating an operation received via the touch panel 22).

In the present embodiment, the control device 30 is configured to refer to the map information database 24 (that is, map information) of the navigation device 20. However, the present disclosure is not limited thereto, the map information including the road network information similar to that of the map information database 24 may be separately stored in the control device 30 or the like, and the control device 30 may refer to such map information.

The control device 30 is a computer that includes, for example, a processor configured to perform various calculations, a storage unit having a non-transitory storage medium (for example, a flash memory) for storing various types of information, and an input and output unit configured to control input and output of data between the inside and the outside of the control device 30 (none is shown), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43 and outputs information indicating the detected rotation angle θm to the EPS ECU 45.

The EPS ECU 45 is a computer that includes, for example, a processor configured to perform various calculations, a storage unit having a non-transitory storage medium for storing various types of information, and an input and output unit configured to control input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering wheel 46 to the control device 30. In this case, the steering speed ω is obtained by, for example, differentiating the steering angle Ost with respect to time.

The driving force control system 50 includes a drive ECU 51, and is configured to control a driving force of the vehicle 1. The drive ECU 51 is a computer that includes, for example, a processor configured to perform various calculations, a storage unit having a non-transitory storage medium for storing various types of information, and an input and output unit configured to control input and output of data between the inside and the outside of the drive ECU 51 (none is shown), and controls the driving force control system 50. The drive ECU 51 is implemented by one or more ECUs. For example, based on an operation on an accelerator pedal 52 provided in the vehicle 1, the drive ECU 51 controls the power output from the drive source of the vehicle 1. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor configured to perform various calculations, a storage unit having a non-transitory storage medium for storing various types of information, and an input and output unit configured to control input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls the electric motor of the brake device such that a braking force corresponding to the operation on the brake pedal 62 is generated. The braking ECU 61 can also control the braking force control system 60 (for example, a brake device) according to an instruction from the control device 30.

The communication unit 70 is a communication interface that communicates with an external device 2 under control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be used for communication between the vehicle 1 and the external device 2.

The alarm device 90 is a device that alarms the driver under control of the control device 30. The alarm device 90 includes, for example, a multi-information display (MID) 91 and a buzzer 92.

The MID 91 is implemented by a display device such as a liquid crystal display or an OLED, and is provided at a position that the driver can visually recognize (for example, in a meter panel of the vehicle 1). For example, the MID 91 displays a predetermined alarm image according to an instruction from the control device 30. The MID 91 may be integrated with the touch panel 22 described above. That is, the “MID 91” in the following description may be interpreted as the “touch panel 22”.

The buzzer 92 is configured to output a predetermined alarm sound. For example, the buzzer 92 outputs a predetermined alarm sound according to an instruction from the control device 30. The buzzer 92 may be integrated with the speaker 23 described above. That is, the “buzzer 92” in the following description may be interpreted as the “speaker 23”.

### 2. Control Device

Next, the control device 30 will be described in more detail. First, in order to simplify and clarify the following description, terms that may be used in the following description will be described.

FIG. 2 is a diagram showing an example of a situation assumed in the present embodiment. In the present embodiment, for example, as shown in FIG. 2, it is assumed that the vehicle 1 travels in a five-way (that is, multi-way) intersection CP where a road Rd1, a road Rd2, a road Rd3, a road Rd4, and a road Rd5 intersect.

### Intersection CP

In FIG. 2, the intersection CP is a five-way intersection at which the road Rd1, the road Rd2, the road Rd3, the road Rd4, and the road Rd5 are connected. For example, the intersection CP may be provided with a right/left-turn road marking Rm at an actual center thereof. Here, the right/left-turn road marking Rm is a road marking that designates a portion for the vehicle 1 or the like to pass through when the vehicle traveling through the intersection CP turns right or left at the intersection CP.

### Road Rd1

The road Rd1 is a road on which the vehicle 1 is currently traveling, and is a two-lane road including a lane Ln11 and a lane Ln12. A travel path boundary Ln11b is a travel path boundary between the lane Ln11 and the lane Ln12, and is, for example, a center line of the road Rd1.

The lane Ln11 is a lane whose traveling direction is a direction from a lower side toward an upper side in FIG. 2, and can also be referred to as a “host lane” on which the vehicle 1 is currently traveling. A travel path boundary Ln11a is a travel path boundary that divides the lane Ln11 and an outside of the road Rd1, and is, for example, a division line, a curb, or the like provided between the lane Ln11 and an outside on a left side of the road Rd1.

The lane Ln12 is a lane whose traveling direction is a direction from the upper side toward the lower side in FIG. 2, and can also be referred to as an “oncoming lane” whose traveling direction is opposite to that of the host lane. A travel path boundary Ln12a is a travel path boundary that divides the lane Ln12 and an outside of the road Rd1, and is, for example, a division line, a curb, or the like provided between the lane Ln12 and an outside on a right side of the road Rd1.

A boundary Rd1a is a boundary between the road Rd1 and the intersection CP. A contact point P1 is an end point of the boundary Rd1a on one side in a width direction of the road Rd1, more specifically, an end point of the boundary Rd1a on a lane Ln11 side of the road Rd1. Further, the contact point P1 can also be referred to as a contact point between the road Rd1 and the road Rd5 at the intersection CP, and more specifically, can also be referred to as a contact point between the travel path boundary Ln11a and a travel path boundary Ln51a to be described later.

A contact point P2 is an end point of the boundary Rd1a on the other side in the width direction of the road Rd1, more specifically, an end point of the boundary Rd1a on a lane Ln12 side of the road Rd1. Further, the contact point P2 can also be referred to as a contact point between the road Rd1 and the road Rd2 at the intersection CP, and more specifically, can also be referred to as a contact point between the travel path boundary Ln12a and a travel path boundary Ln22a to be described later.

### Road Rd2

The road Rd2 is a road present on a right side (that is, the other side in the vehicle width direction) relative to the vehicle 1, and is a two-lane road including a lane Ln21 and a lane Ln22. A travel path boundary Ln21b is a travel path boundary between the lane Ln21 and the lane Ln22, and is, for example, a center line of the road Rd2.

The lane Ln21 is a lane whose traveling direction is a direction from the intersection CP toward a right lower side in FIG. 2. A travel path boundary Ln21a is a travel path boundary that divides the lane Ln21 and an outside of the road Rd2, and is, for example, a division line, a curb, or the like provided between the lane Ln21 and an outside on a far side of the road Rd2.

The lane Ln22 is a lane whose traveling direction is a direction from the right lower side toward the intersection CP in FIG. 2. A travel path boundary Ln22a is a travel path boundary that divides the lane Ln22 and an outside of the road Rd2, and is, for example, a division line, a curb, or the like provided between the lane Ln22 and an outside on a near side of the road Rd2.

A boundary Rd2a is a boundary between the road Rd2 and the intersection CP. The contact point P2 is an end point of the boundary Rd2a on one side in a width direction of the road Rd2, more specifically, an end point of the boundary Rd2a on a lane Ln22 side of the road Rd2. Further, the contact point P2 can also be referred to as a contact point between the road Rd2 and the road Rd1 at the intersection CP, and more specifically, can also be referred to as a contact point between the travel path boundary Ln22a and the travel path boundary Ln12a.

A contact point P3 is an end point of the boundary Rd2a on the other side in the width direction of the road Rd2, more specifically, an end point of the boundary Rd2a on a lane Ln21 side of the road Rd2. Further, the contact point P3 can also be referred to as a contact point between the road Rd2 and the road Rd3 at the intersection CP, and more specifically, can also be referred to as a contact point between the travel path boundary Ln21a and a travel path boundary Ln32a to be described later.

### Road Rd3

The road Rd3 is a two-lane road including a lane Ln31 and a lane Ln32. A travel path boundary Ln31b is a travel path boundary between the lane Ln31 and the lane Ln32, and is, for example, a center line of the road Rd3.

The lane Ln31 is a lane whose traveling direction is a direction from the intersection CP toward a right upper side in FIG. 2. A travel path boundary Ln31a is a travel path boundary that divides the lane Ln31 and an outside of the road Rd3, and is, for example, a division line, a curb, or the like provided between the lane Ln31 and an outside on a left far side of the road Rd3.

The lane Ln32 is a lane whose traveling direction is a direction from the right upper side toward the intersection CP in FIG. 2. A travel path boundary Ln32a is a travel path boundary that divides the lane Ln32 and an outside of the road Rd3, and is, for example, a division line, a curb, or the like provided between the lane Ln32 and an outside on a right front side of the road Rd3.

A boundary Rd3a is a boundary between the road Rd3 and the intersection CP. The contact point P3 is an end point of the boundary Rd3a on one side in a width direction of the road Rd3, more specifically, an end point of the boundary Rd3a on a lane Ln32 side of the road Rd3. Further, the contact point P3 can also be referred to as a contact point between the road Rd3 and the road Rd2 at the intersection CP, and more specifically, can also be referred to as a contact point between the travel path boundary Ln32a and the travel path boundary Ln21a.

A contact point P4 is an end point of the boundary Rd3a on the other side in the width direction of the road Rd3, more specifically, an end point of the boundary Rd3a on a lane Ln31 side of the road Rd3. Further, the contact point P4 can also be referred to as a contact point between the road Rd3 and the road Rd4 at the intersection CP, and more specifically, can also be referred to as a contact point between the travel path boundary Ln31a and a travel path boundary Ln42a to be described later.

### Road Rd4

The road Rd4 is a two-lane road including a lane Ln41 and a lane Ln42. A travel path boundary Ln41b is a travel path boundary between the lane Ln41 and the lane Ln42, and is, for example, a center line of the road Rd4.

The lane Ln41 is a lane whose traveling direction is a direction from the intersection CP toward a left upper side in FIG. 2. A travel path boundary Ln41a is a travel path boundary that divides the lane Ln41 and an outside of the road Rd4, and is, for example, a division line, a curb, or the like provided between the lane Ln41 and an outside on a left front side of the road Rd4.

The lane Ln42 is a lane whose traveling direction is a direction from the left upper side toward the intersection CP in FIG. 2. A travel path boundary Ln42a is a travel path boundary that divides the lane Ln42 and an outside of the road Rd4, and is, for example, a division line, a curb, or the like provided between the lane Ln42 and an outside on a right far side of the road Rd4.

A boundary Rd4a is a boundary between the road Rd4 and the intersection CP. The contact point P4 is an end point of the boundary Rd4a on one side in a width direction of the road Rd4, more specifically, an end point of the boundary Rd4a on a lane Ln42 side of the road Rd4. Further, the contact point P4 can also be referred to as a contact point between the road Rd4 and the road Rd3 at the intersection CP, and more specifically, can also be referred to as a contact point between the travel path boundary Ln42a and the travel path boundary Ln31a.

A contact point P5 is an end point of the boundary Rd4a on the other side in the width direction of the road Rd4, more specifically, an end point of the boundary Rd4a on a lane Ln41 side of the road Rd4. Further, the contact point P5 can also be referred to as a contact point between the road Rd4 and the road Rd5 at the intersection CP, and more specifically, can also be referred to as a contact point between the travel path boundary Ln41a and the travel path boundary Ln52a to be described later.

### Road Rd5

The road Rd5 is a two-lane road including a lane Ln51 and a lane Ln52. A travel path boundary Ln51b is a travel path boundary between the lane Ln51 and the lane Ln52, and is, for example, a center line of the road Rd5.

The lane Ln51 is a lane whose traveling direction is a direction from the intersection CP toward a left lower side in FIG. 2. A travel path boundary Ln51a is a travel path boundary that divides the lane Ln51 and an outside of the road Rd5, and is, for example, a division line, a curb, or the like provided between the lane Ln51 and an outside on a near side of the road Rd5.

The lane Ln52 is a lane whose traveling direction is a direction from the left lower side toward the intersection CP in FIG. 2. A travel path boundary Ln52a is a travel path boundary that divides the lane Ln52 and an outside of the road Rd5, and is, for example, a division line, a curb, or the like provided between the lane Ln52 and an outside on a far side of the road Rd5.

A boundary Rd5a is a boundary between the road Rd5 and the intersection CP. The contact point P5 is an end point of the boundary Rd5a on one side in a width direction of the road Rd5, more specifically, an end point of the boundary Rd5a on a lane Ln52 side of the road Rd5. Further, the contact point P5 can also be referred to as a contact point between the road Rd5 and the road Rd4 at the intersection CP, and more specifically, can also be referred to as a contact point between the travel path boundary Ln52a and the travel path boundary Ln41a.

The contact point P1 is an end point of the boundary Rd5a on the other side in the width direction of the road Rd5, more specifically, an end point of the boundary Rd5a on a lane Ln51 side of the road Rd5.

### Example of Processing Implemented With Functional Units of Control Device

The control device 30 includes, for example, a recognition unit 31, a trajectory generation unit 32, and a travel control unit 33 as functional units implemented by the processor executing a program stored in the storage unit of the control device 30.

The recognition unit 31 recognizes a surrounding situation of the vehicle 1. For example, the recognition unit 31 performs sensor fusion processing on detection results obtained by some or all of the camera 111, the sonar 112, and the radar 113 in the external sensor 11, and recognizes the surrounding situation of the vehicle 1 based on a processing result.

The recognition unit 31 recognizes a position, a type, a speed, an acceleration, and the like of an object present in the surroundings the vehicle 1 as the surrounding situation of the vehicle 1. At this time, the recognition unit 31 recognizes the position of the object as a position on absolute coordinates in which a representative point (for example, a center of gravity or a center of a drive shaft) of the vehicle 1 is set as an origin. Accordingly, a relative position between the vehicle 1 and the object present in the surroundings can be recognized. In the absolute coordinate system, the position of the object may be represented using a representative point such as a center of gravity or a corner of the object, or may be represented as an area.

Examples of objects that can be recognized by the recognition unit 31 include traffic participants such as other vehicles and pedestrians, travel path boundaries that define lanes such as division lines, curbs and separation zones, road structures such as guard rails and road shoulders, and road markings (for example, the right/left-turn road marking Rm) or road signs. The first recognition unit 31 may recognize, for example, other road events such as a traffic light, a stop line, a crosswalk, a branch, a junction, an interchange, and a tollbooth of a toll road.

According to such a recognition unit 31, for example, the road marking such as the travel path boundary of each of the road Rd1 to the road Rd5 shown in FIG. 2 or the right/left-turn road marking Rm can be recognized. Further, the recognition unit 31 can recognize a shape of the host lane that is a lane on which the vehicle 1 travels, the intersection CP present in the traveling direction of the vehicle 1, and the like based on a recognition result of the travel path boundary. For example, the recognition unit 31 may recognize the intersection CP present in the traveling direction of the vehicle 1 based on the current position of the vehicle 1 specified by the navigation device 20 (for example, the GNSS receiver 21) and the map information such as the map information database 24.

When the intersection CP present in the traveling direction of the vehicle 1 is recognized by the recognition unit 31, the trajectory generation unit 32 generates a travel trajectory from an entry position PA of the vehicle 1 at the intersection CP to an exit position PE of the vehicle 1 at the intersection CP. Here, the travel trajectory is a trajectory for the vehicle 1 to travel when passing through the intersection CP, and can also be referred to as a target travel line.

In the following description, when the vehicle 1 passes through the intersection CP, a road including the entry position PA to the intersection CP is also referred to as an “entry road RdA”, and a road including the exit position PE from the intersection CP is also referred to as an “exit road RdE”. The entry road RdA is an example of a first road in the present disclosure, and the exit road RdE is an example of a second road in the present disclosure.

When generating the travel trajectory, for example, the trajectory generation unit 32 first specifies an intersection angle θx (hereinafter, it is assumed that 0° ≤ intersection angle θx≤180° ) at the intersection CP between the entry road RdA and the exit road RdE. As an example, the trajectory generation unit 32 specifies the intersection angle θx based on the recognition result of the recognition unit 31. In this case, for example, based on recognition results of the entry road RdA and the exit road RdE from the recognition unit 31, the trajectory generation unit 32 may geometrically obtain an angle formed by a virtual line obtained by extending a center line (or the travel path boundary) of the entry road RdA toward the intersection CP and a virtual line obtained by extending a center line (or the travel path boundary) of the exit road RdE toward the intersection CP, and specify the angle formed by these virtual lines as the intersection angle θx. In this way, the intersection angle θx can be specified based on the recognition result of the recognition unit 31 even if no information on the intersection CP is prepared in advance.

As another example, the trajectory generation unit 32 may specify the intersection angle θx based on the map information such as the map information database 24. In this case, for example, the trajectory generation unit 32 may geometrically obtain an angle formed by a link of the entry road RdA and a link of the exit road RdE which are connected to a node of the intersection CP, with reference to the map information such as the map information database 24, and specify the angle formed by the links as the intersection angle θx. In this way, the intersection angle θx can be specified based on the map information including general road network information.

Then, the trajectory generation unit 32 generates a travel trajectory corresponding to the intersection angle θx. For example, it is assumed that the intersection angle θx is within a predetermined first angle range. Here, the first angle range is an angle range including 180 degrees, and can be, for example, an angle range having a predetermined angle (for example, 91 degrees) larger than 90 degrees and smaller than 180 degrees as a lower limit value and 180 degrees as an upper limit value. As an example, in the present embodiment, an angle range from 121 degrees to 180 degrees is set as the first angle range.

When the intersection angle θx is within such a first angle range, the trajectory generation unit 32 first specifies, based on the recognition result of the recognition unit 31, a first reference point Rp1 which is an end point of a boundary between the entry road RdA and the intersection CP on one side in a width direction of the entry road RdA, and a second reference point Rp2 which is an end point of a boundary between the exit road RdE and the intersection CP on one side in a width direction of the exit road RdE. At this time, for example, the trajectory generation unit 32 specifies, as the first reference point Rp1, an end point closer to the entry position PA (in other words, on a host lane side) among both end points of the boundary between the entry road RdA and the intersection CP in the width direction of the entry road RdA, and specifies, as the second reference point Rp2, an end point closer to the exit position PE (in other words, on a destination lane side) among both end points of the boundary between the exit road RdE and the intersection CP in the width direction of the exit road RdE.

Next, the trajectory generation unit 32 derives, based on the specified first reference point Rp1 and second reference point Rp2, a first reference line RL1 which is a virtual line segment passing through the first reference point Rp1 and the second reference point Rp2. For example, the first reference line RL1 can be geometrically obtained from a position (in other words, coordinates) of the first reference point Rp1 and a position of the second reference point Rp2.

Then, the trajectory generation unit 32 generates the travel trajectory based on the derived first reference line RL1. At this time, the trajectory generation unit 32 generates, for example, a travel trajectory passing between the first reference line RL1 and a predetermined straight-travel reference point Px at the intersection CP.

The straight-travel reference point Px can be, for example, a point indicated by a node corresponding to the intersection CP in the map information such as the map information database 24. Accordingly, the trajectory generation unit 32 can set an appropriate straight-travel reference point Px based on the map information including general road network information such as the map information database 24.

Further, the trajectory generation unit 32 may set the straight-travel reference point Px based on the recognition result of the recognition unit 31. In this case, for example, the trajectory generation unit 32 first specifies, based on the recognition result of the recognition unit 31, a third reference point Rp3 which is an end point of the boundary between the entry road RdA and the intersection CP on the other side in the width direction of the entry road RdA, and a fourth reference point Rp4 which is an end point of the boundary between the exit road RdE and the intersection CP on the other side in the width direction of the exit road RdE. At this time, for example, the trajectory generation unit 32 specifies, as the third reference point Rp3, an end point (for example, an end point farther from the entry position PA) that is not the first reference point Rp1 among the both end points of the boundary between the entry road RdA and the intersection CP in the width direction of the entry road RdA, and specifies, as the fourth reference point Rp4, an end point (for example, an end point farther from the exit position PE) that is not the second reference point Rp2 among the both end points of the boundary between the exit road RdE and the intersection CP in the width direction of the exit road RdE.

Then, the trajectory generation unit 32 may derive, based on the second reference point Rp2 and the third reference point Rp3, a second reference line RL2 which is a virtual line segment passing through the second reference point Rp2 and the third reference point Rp3, may derive, based on the first reference point Rp1 and the fourth reference point Rp4, a third reference line RL3 which is a virtual line segment passing through the first reference point Rp1 and the fourth reference point Rp4, and may set an intersection point between the second reference line RL2 and the third reference line RL3 as the straight-travel reference point Px. In this way, the trajectory generation unit 32 can set an appropriate straight-travel reference point Px based on the recognition result of the recognition unit 31.

As another example, the trajectory generation unit 32 may specify a point at which the right/left-turn road marking Rm recognized by the recognition unit 31 is provided, and use the point as the straight-travel reference point Px. In this way, an appropriate straight-travel reference point Px in consideration of the point where the right/left-turn road marking Rm is provided can be set.

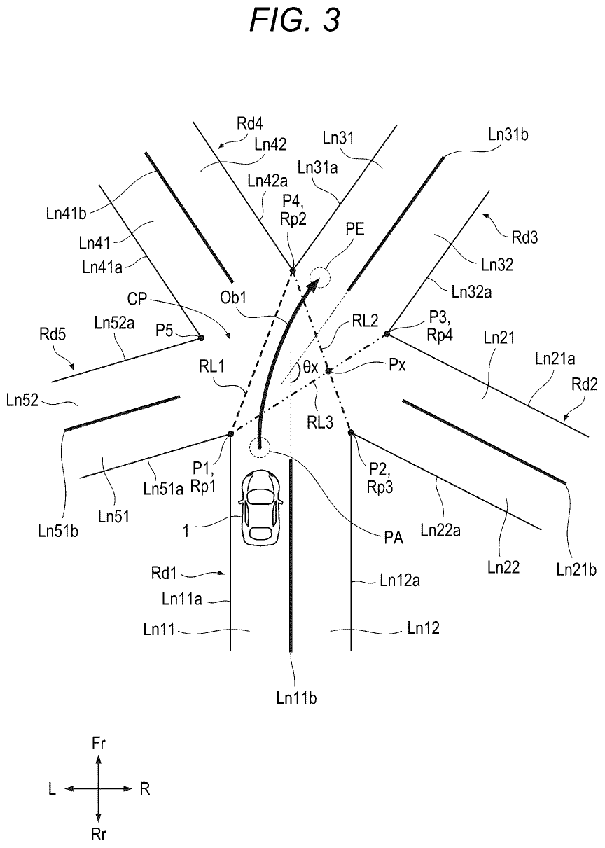

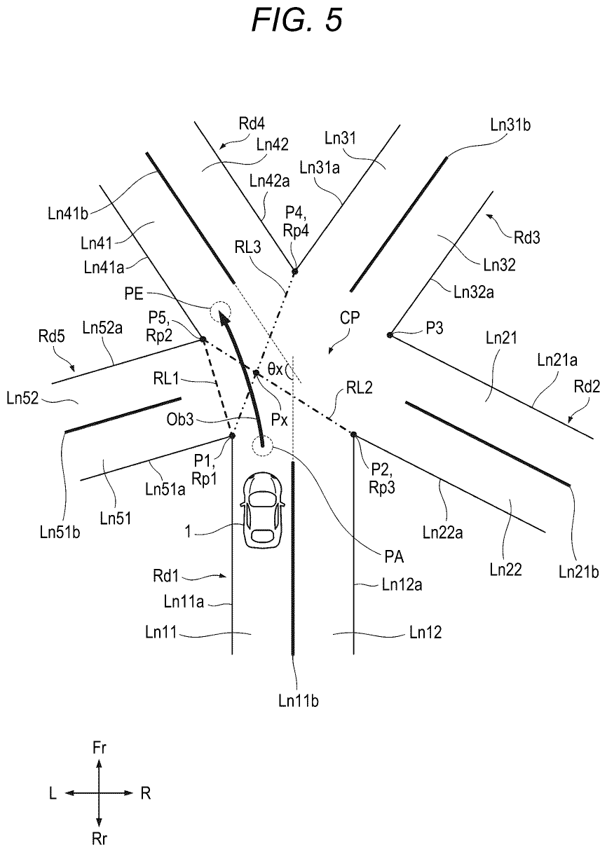

A specific example of the travel trajectory generated by the trajectory generation unit 32 when the intersection angle θx is within the first angle range will be described later with reference to FIGS. 3 and 5.

On the other hand, it is assumed that the intersection angle is within a second angle range smaller than the first angle range. Here, the second angle range is an angle range with a lower limit value (in other words, a minimum value) larger than 0 degree and an upper limit value (in other words, a maximum value) smaller than the lower limit value of the first angle range, and is, for example, an angle range including 90 degrees. As an example, in the present embodiment, an angle range from 30 degrees to 120 degrees is set as the second angle range.

When the intersection angle θx is within such a second angle range, for example, the trajectory generation unit 32 first specifies the first reference point Rp1 and the second reference point Rp2 based on the recognition result of the recognition unit 31 and derives the first reference line RL1 based on the first reference point Rp1 and the second reference point Rp2, as in the case where the intersection angle θx is within the first angle range. In this case, the trajectory generation unit 32 generates a travel trajectory turning along the first reference line RL1 based on the derived first reference line RL1.

When the intersection angle θx is within the second angle range, the trajectory generation unit 32 may generate a different travel trajectory depending on whether the vehicle 1 turns right or left at the intersection CP. More specifically, for example, when the intersection angle θx is within the second angle range and the vehicle 1 turns right at the intersection CP, the trajectory generation unit 32 may generate a travel trajectory turning along the first reference line RL1. On the other hand, when the intersection angle θx is within the second angle range and the vehicle 1 turns left at the intersection CP, the trajectory generation unit 32 may generate a travel trajectory from the entry position PA toward the exit position PE along a travel path boundary of the entry road RdA or the exit road RdE.

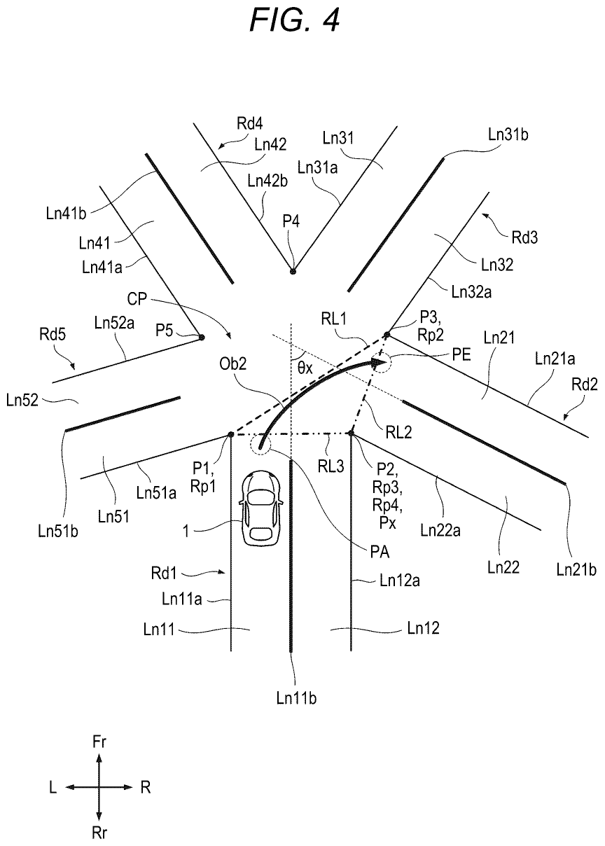

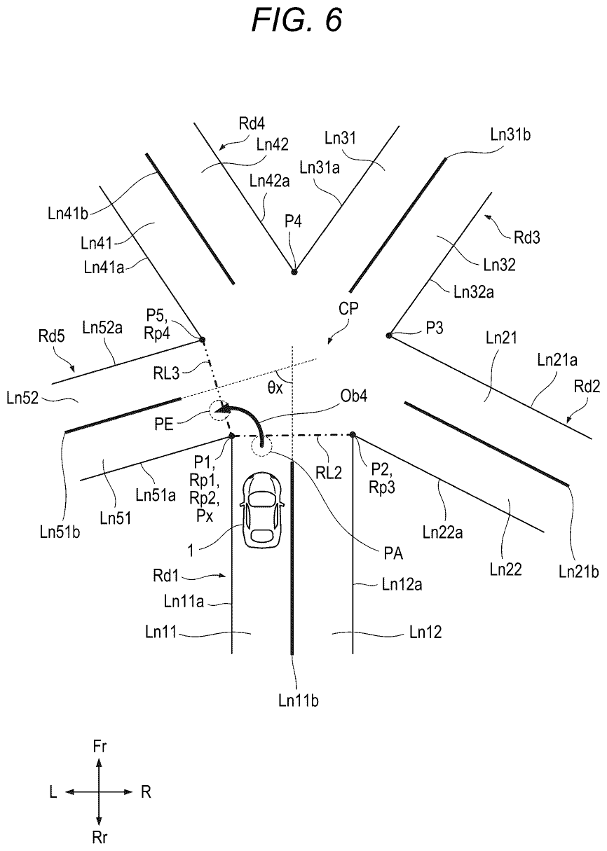

A specific example of the travel trajectory generated by the trajectory generation unit 32 when the intersection angle θx is within the second angle range will be described later with reference to FIGS. 4 and 6.

The travel control unit 33 causes the vehicle 1 to travel based on the travel trajectory generated by the trajectory generation unit 32. Specifically, the travel control unit 33 may control steering of the vehicle 1 via the EPS system 40 such that the vehicle 1 travels while tracing the travel trajectory (in other words, the target travel line) generated by the trajectory generation unit 32. At this time, the travel control unit 33 may control the driving force of the vehicle 1 via the driving force control system 50, or may control the braking force of the vehicle 1 via the braking force control system 60.

The control device 30 (for example, the trajectory generation unit 32) can specify (in other words, determine) a road (that is, a direction) the vehicle 1 is about to travel at the intersection CP based on, for example, route guidance performed by the navigation device 20 or a lighting state of a direction indicator (not shown) provided in the vehicle 1. When the vehicle 1 is an autonomous vehicle that travels autonomously, the control device 30 may specify the road the vehicle 1 is about to travel at the intersection CP based on a travel plan generated based on a route to a destination.

### 3. Specific Example of Travel Trajectory Generated by Control Device

Next, a specific example of the travel trajectory generated by the control device 30 using the function of the trajectory generation unit 32 will be described with reference to FIGS. 3 to 6. In the drawings of FIGS. 3 to 6, similarly to the example shown in FIG. 2, the vehicle 1 travels on the road Rd1 toward the intersection CP, and the intersection CP is present in the traveling direction (that is, in front) of the vehicle 1.

### Example of Travel Trajectory Generated When Vehicle Travels Substantially Straight Through Intersection

FIG. 3 is a diagram showing an example of a travel trajectory generated when the vehicle 1 travels through the intersection CP from the road Rd1 to the road Rd3. That is, in the example shown in FIG. 3, the entry road RdA is the road Rd1, and the exit road RdE is the road Rd3. In the present example, the intersection angle θx at the intersection CP between the road Rd1 which is the entry road RdA and the road Rd3 which is the exit road RdE is about 150 degrees (that is, within the first angle range), and the vehicle 1 is about to travel to the road Rd3 by traveling straight slightly to a right side at the intersection CP.

In the present example, the entry position PA is, for example, a position on the boundary Rd1a (see FIG. 2) between the road Rd1 and the intersection CP or in the vicinity of the boundary Rd1a, and substantially at a center in the width direction of the lane Ln11 which is the host lane. The exit position PE is, for example, a position that is on the boundary Rd3a (see FIG. 2) between the road Rd3 and the intersection CP or in the vicinity of the boundary Rd3a and, substantially at a center in the width direction of the lane Ln31 that is the destination lane.

As shown in FIG. 3, in the present example, the trajectory generation unit 32 specifies the contact point P1 as the first reference point Rp1, the contact point P4 as the second reference point Rp2, the contact point P2 as the third reference point Rp3, and the contact point P3 as the fourth reference point Rp4.

Then, the trajectory generation unit 32 derives a line segment passing through the first reference point Rp1 (here, the contact point P1) and the second reference point Rp2 (here, the contact point P4) as the first reference line RL1, a line segment passing through the second reference point Rp2 and the third reference point Rp3 (here, the contact point P2) as the second reference line RL2, and a line segment passing through the first reference point Rp1 and the fourth reference point Rp4 (here, the contact point P3) as the third reference line RL3. The trajectory generation unit 32 sets, for example, an intersection point between the second reference line RL2 and the third reference line RL3 as the straight-travel reference point Px.

In the present example, since the intersection angle θx is within the first angle range, as shown in FIG. 3, the trajectory generation unit 32 generates a travel trajectory Ob1 from the entry position PA toward the exit position PE passing between the first reference line RL1 and the straight-travel reference point Px. Accordingly, an appropriate travel trajectory Ob1 in consideration of another vehicle traveling through the intersection CP (for example, another vehicle traveling in an oncoming lane) can be generated even if no information on the intersection CP is prepared in advance.

### Example of Travel Trajectory Generated When Vehicle Turns Right at Intersection

FIG. 4 is a diagram showing an example of the travel trajectory generated when the vehicle 1 travels through the intersection CP from the road Rd1 to the road Rd2. That is, in the example shown in FIG. 4, the entry road RdA is the road Rd1, and the exit road RdE is the road Rd2. In the present example, the intersection angle θx at the intersection CP between the road Rd1 which is the entry road RdA and the road Rd2 which is the exit road RdE is about 60 degrees (that is, within the second angle range), and the vehicle 1 is about to travel to the road Rd2 by turning right at the intersection CP.

In the present example, the entry position PA is, for example, the position on the boundary Rd1a (see FIG. 2) between the road Rd1 and the intersection CP or in the vicinity of the boundary Rd1a, and substantially at the center in the width direction of the lane Ln11 which is the host lane. The exit position PE is, for example, a position that is on the boundary Rd2a (see FIG. 2) between the road Rd2 and the intersection CP or in the vicinity of the boundary Rd2a and, substantially at a center in the width direction of the lane Ln21 that is the destination lane.

As shown in FIG. 4, in the present example, the trajectory generation unit 32 specifies the contact point P1 as the first reference point Rp1, the contact point P3 as the second reference point Rp2, and the contact point P2 as the third reference point Rp3 and the fourth reference point Rp4.

Then, the trajectory generation unit 32 derives a line segment passing through the first reference point Rp1 (here, the contact point P1) and the second reference point Rp2 (here, the contact point P3) as the first reference line RL1, a line segment passing through the second reference point Rp2 and the third reference point Rp3 (here, the contact point P2) as the second reference line RL2, and a line segment passing through the first reference point Rp1 and the fourth reference point Rp4 (here, the contact point P2) as the third reference line RL3. The trajectory generation unit 32 sets, for example, an intersection point (here, the contact point P2) between the second reference line RL2 and the third reference line RL3 as the straight-travel reference point Px.

In the present example, since the intersection angle θx is within the second angle range, as shown in FIG. 4, the trajectory generation unit 32 generates a travel trajectory Ob2 from the entry position PA toward the exit position PE turning along the first reference line RL1. At this time, the trajectory generation unit 32 may generate, as the travel trajectory Ob2, a travel trajectory including a first trajectory on which the vehicle 1 travels straight from the entry position PA to a position a predetermined distance before the first reference line RL1 and a second trajectory that is curved along the first reference line RL1 from an end of the first trajectory. In other words, a travel trajectory in which the vehicle 1 travels straight from the entry position PA to a position a predetermined distance before the first reference line RL1 and then turns along the first reference line RL1 toward the exit position PE may be generated as the travel trajectory Ob2. Here, the predetermined distance is preferably as small as possible within a range in which the vehicle 1 can turn right from the viewpoint of preventing the vehicle 1 from making an excessively sharp turn. In order to reduce the predetermined distance as much as possible, it is preferable to increase a curvature (that is, the degree of curvature) of the second trajectory as much as possible in consideration of the intersection angle θx and a minimum turning radius of the vehicle 1.

In this way, when the intersection angle θx is within the second angle range, the trajectory generation unit 32 generates the travel trajectory Ob2 turning along the first reference line RL1, and thus the travel trajectory Ob2 enabling the vehicle 1 to appropriately turn right at the intersection CP without making an excessively small or large turn can be generated even if no information on the intersection CP is prepared in advance.

When the vehicle 1 turns right at the intersection CP in this way, the trajectory generation unit 32 may not specify the third reference point Rp3 and the fourth reference point Rp4 and may not derive the second reference line RL2 and the third reference line RL3. This is because, when the vehicle 1 turns right at the intersection CP, the travel trajectory Ob2 can be generated as long as there is the first reference line RL1 even if there is no second reference line RL2 and third reference line RL3.

### Another Example of Travel Trajectory Generated When Vehicle Travels substantially Straight Through Intersection

FIG. 5 is a diagram showing an example of the travel trajectory generated when the vehicle 1 travels through the intersection CP from the road Rd1 to the road Rd4. That is, in the example shown in FIG. 5, the entry road RdA is the road Rd1, and the exit road RdE is the road Rd4. In the present example, the intersection angle θx at the intersection CP between the road Rd1 which is the entry road RdA and the road Rd4 which is the exit road RdE is about 170 degrees (that is, within the first angle range), and the vehicle 1 is about to travel to the road Rd4 by traveling straight slightly to a left side at the intersection CP.

In the present example, the entry position PA is, for example, the position on the boundary Rd1a (see FIG. 2) between the road Rd1 and the intersection CP or in the vicinity of the boundary Rd1a, and substantially at the center in the width direction of the lane Ln11 which is the host lane. The exit position PE is, for example, a position that is on the boundary Rd4a (see FIG. 2) between the road Rd4 and the intersection CP or in the vicinity of the boundary Rd4a and, substantially at a center in the width direction of the lane Ln41 that is the destination lane.

As shown in FIG. 5, in the present example, the trajectory generation unit 32 specifies the contact point P1 as the first reference point Rp1, the contact point P5 as the second reference point Rp2, the contact point P2 as the third reference point Rp3, and the contact point P4 as the fourth reference point Rp4.

Then, the trajectory generation unit 32 derives a line segment passing through the first reference point Rp1 (here, the contact point P1) and the second reference point Rp2 (here, the contact point P5) as the first reference line RL1, a line segment passing through the second reference point Rp2 and the third reference point Rp3 (here, the contact point P2) as the second reference line RL2, and a line segment passing through the first reference point Rp1 and the fourth reference point Rp4 (here, the contact point P4) as the third reference line RL3. The trajectory generation unit 32 sets, for example, the intersection point between the second reference line RL2 and the third reference line RL3 as the straight-travel reference point Px.

In the present example, since the intersection angle θx is within the first angle range, as shown in FIG. 5, the trajectory generation unit 32 generates a travel trajectory Ob3 from the entry position PA toward the exit position PE passing between the first reference line RL1 and the straight-travel reference point Px. Accordingly, an appropriate travel trajectory Ob3 in consideration of another vehicle traveling through the intersection CP (for example, another vehicle traveling in an oncoming lane) can be generated even if no information on the intersection CP is prepared in advance.

### Example of Travel Trajectory Generated When Vehicle Turns Left at Intersection

FIG. 6 is a diagram showing an example of a travel trajectory generated when the vehicle 1 travels through the intersection CP from the road Rd1 to the road Rd5. That is, in the example shown in FIG. 6, the entry road RdA is the road Rd1, and the exit road RdE is the road Rd5. In the present example, the intersection angle θx at the intersection CP between the road Rd1 which is the entry road RdA and the road Rd5 which is the exit road RdE is about 80 degrees (that is, within the second angle range), and the vehicle 1 is about to travel to the road Rd5 by turning left at the intersection CP.

In the present example, the entry position PA is, for example, the position on the boundary Rd1a (see FIG. 2) between the road Rd1 and the intersection CP or in the vicinity of the boundary Rd1a, and substantially at the center in the width direction of the lane Ln11 which is the host lane. The exit position PE is, for example, a position that is on the boundary Rd5a (see FIG. 2) between the road Rd5 and the intersection CP or in the vicinity of the boundary Rd5a and, substantially at a center in the width direction of the lane Ln51 that is the destination lane.

As shown in FIG. 6, in the present example, the trajectory generation unit 32 generates, based on the recognition result of the recognition unit 31, a travel trajectory Ob4 from the entry position PA toward the exit position PE along the travel path boundary Ln11a on a left side of the lane Ln11 that is the host lane (that is, a side of the road Rd5 which is the exit road RdE). Accordingly, even if no information on the intersection CP is prepared in advance, the travel trajectory Ob4 enabling the vehicle 1 to appropriately turn left at the intersection CP without making an excessively small or large turn can be generated.

When the vehicle 1 turns left at the intersection CP and the vehicle 1 has already entered the intersection CP, the trajectory generation unit 32 may generate the travel trajectory Ob4 from the current position of the vehicle 1 toward the exit position PE. When the vehicle 1 turns left at the intersection CP in this way, the trajectory generation unit 32 may specify the first reference point Rp1 to the fourth reference point Rp4 or derive the first reference line RL1 to the third reference line RL3, or may not specify or derive these reference points or reference lines.

### 4. Example of Processing Procedure Performed by Control Device

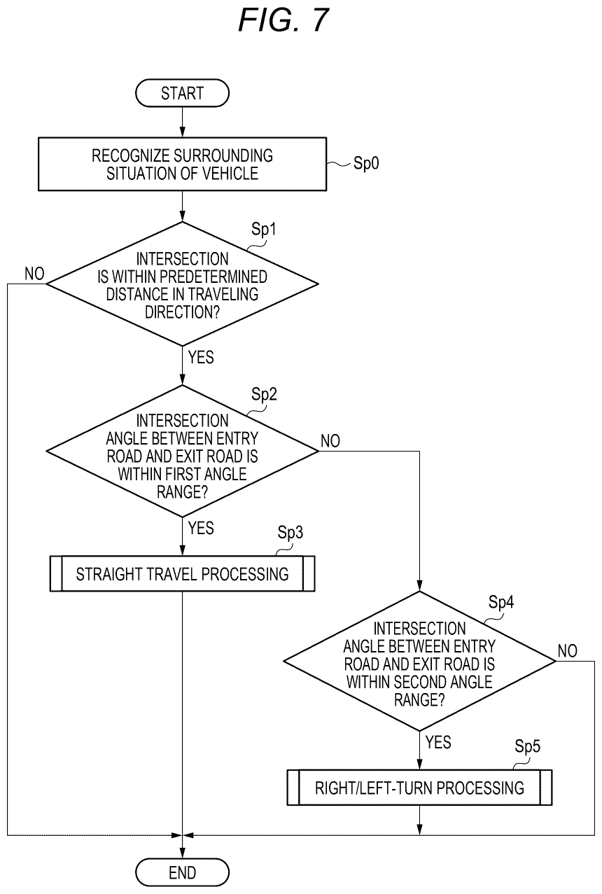

Next, an example of a processing procedure performed by the control device 30 will be described. FIGS. 7 to 9 are flowcharts (Flowcharts 1 to 3) showing an example of the processing procedure performed by the control device 30. For example, when an ignition power supply of the vehicle 1 is turned on, the control device 30 performs a series of processing shown in FIGS. 7 to 9 at a predetermined cycle.

As shown in FIG. 7, the control device 30 recognizes, for example, the surrounding situation of the vehicle 1 (step Sp0). Then, the control device 30 determines whether there is an intersection CP within a predetermined distance (for example, 30 [m]) in the traveling direction of the vehicle 1 based on a recognition result of the surrounding situation of the vehicle 1 (step Sp1).

When it is determined that there is the intersection CP (step Sp1: YES), the control device 30 specifies the intersection angle θx at the intersection CP between the entry road RdA and the exit road RdE, and determines whether the intersection angle θx is within the first angle range (step Sp2). When it is determined that the intersection angle θx is within the first angle range (step Sp2: YES), the control device 30 performs straight travel processing to be described later (step Sp3), and ends the series of processing shown in FIGS. 7 to 9.

On the other hand, when it is determined that the intersection angle θx is not within the first angle range (step Sp2: NO), the control device 30 determines whether the intersection angle θx is within the second angle range (step Sp4). When it is determined that the intersection angle θx is within the second angle range (step Sp4: YES), the control device 30 performs right/left-turn processing to be described later (step Sp5), and ends the series of processing shown in FIGS. 7 to 9.

When it is determined that the intersection angle θx is not within the second angle range (step Sp4: NO), the control device 30 ends the series of processing shown in FIGS. 7 to 9 without performing the right/left-turn processing in step Sp5. Accordingly, even when the intersection angle θx is too small to fall within the second angle range, for example, even when the vehicle 1 makes a so-called “U-turn” at the intersection CP, occurrence of an unintended problem due to performing of the right/left-turn processing in step Sp5 can be prevented. When the intersection angle θx is too small to fall within the second angle range, the control device 30 may perform predetermined processing of generating a travel trajectory for a U-turn instead of the right/left-turn processing in step Sp5.

### Straight Travel Processing

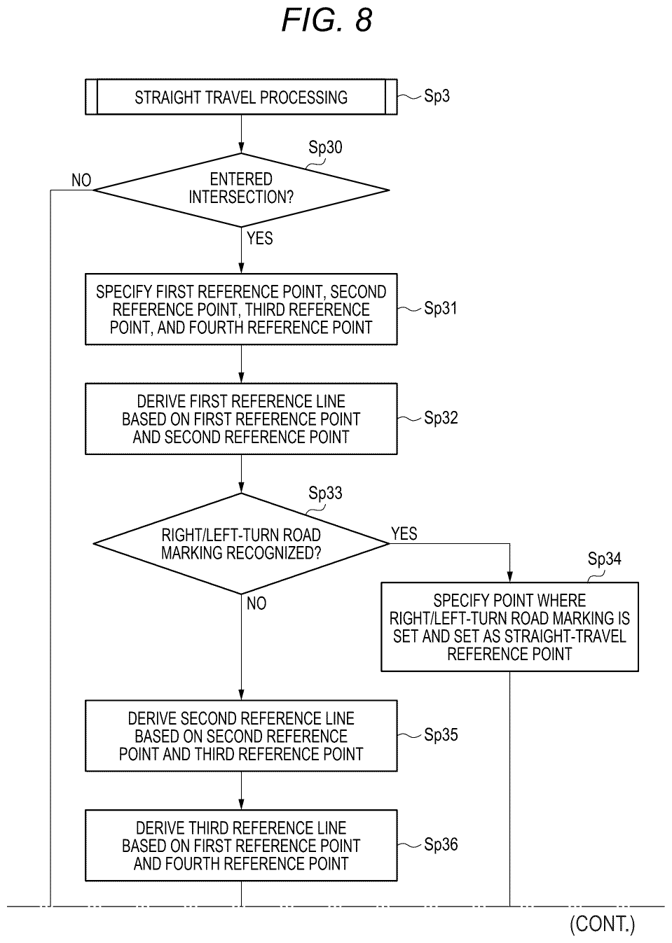

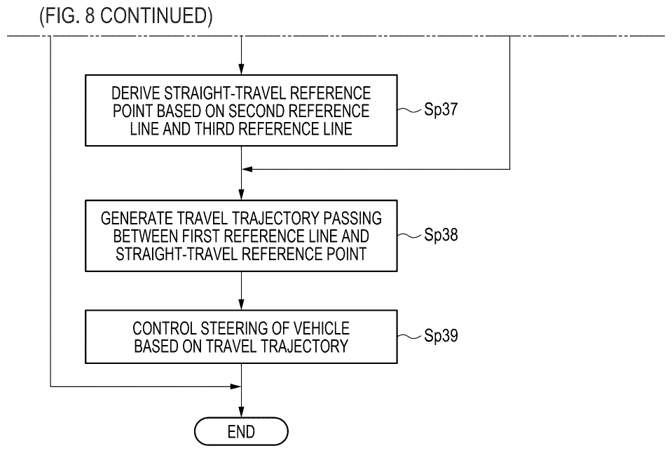

As shown in FIG. 8, in the straight travel processing of step Sp3, the control device 30 first determines whether the vehicle 1 has entered the intersection CP (step Sp30). When it is determined that the vehicle 1 has entered the intersection CP (step Sp30: YES), the control device 30 specifies the first reference point Rp1, the second reference point Rp2, the third reference point Rp3, and the fourth reference point Rp4 (step Sp31).

Next, the control device 30 derives the first reference line RL1 based on the first reference point Rp1 and the second reference point Rp2 (step Sp32).

Next, the control device 30 determines whether the right/left-turn road marking Rm has been recognized (step Sp33). When it is determined that the right/left-turn road marking Rm has been recognized (step Sp33: YES), the control device 30 specifies a point where the right/left-turn road marking Rm is provided, sets the point as the straight-travel reference point Px (step Sp34), and proceeds to processing of step Sp38.

On the other hand, when it is determined that the right/left-turn road marking Rm has not been recognized (step Sp33: NO), the control device 30 derives the second reference line RL2 based on the second reference point Rp2 and the third reference point Rp3 (step Sp35).

Next, the control device 30 derives the third reference line RL3 based on the first reference point Rp1 and the fourth reference point Rp4 (step Sp36).

Next, the control device 30 derives the intersection point between the second reference line RL2 and the third reference line RL3 as the straight-travel reference point Px based on the second reference line RL2 and the third reference line RL3 (step Sp37), and proceeds to the processing of step Sp38.

In the processing of step Sp38, the control device 30 generates a travel trajectory (for example, the travel trajectory Ob1 shown in FIG. 3 or the travel trajectory Ob3 shown in FIG. 5) passing between the first reference line RL1 and the straight-travel reference point Px (step Sp38).

Then, the control device 30 controls the steering of the vehicle 1 based on the travel trajectory generated by the processing of step Sp38 (step Sp39), and ends the current straight travel processing.

In the straight travel processing of step Sp3, the control device 30 may set a point indicated by a node corresponding to the intersection CP in the map information such as the map information database 24 as the straight-travel reference point Px. In such a case, the processing in steps Sp34 to Sp37 described above is unnecessary.

### Right/Left-Turn Processing

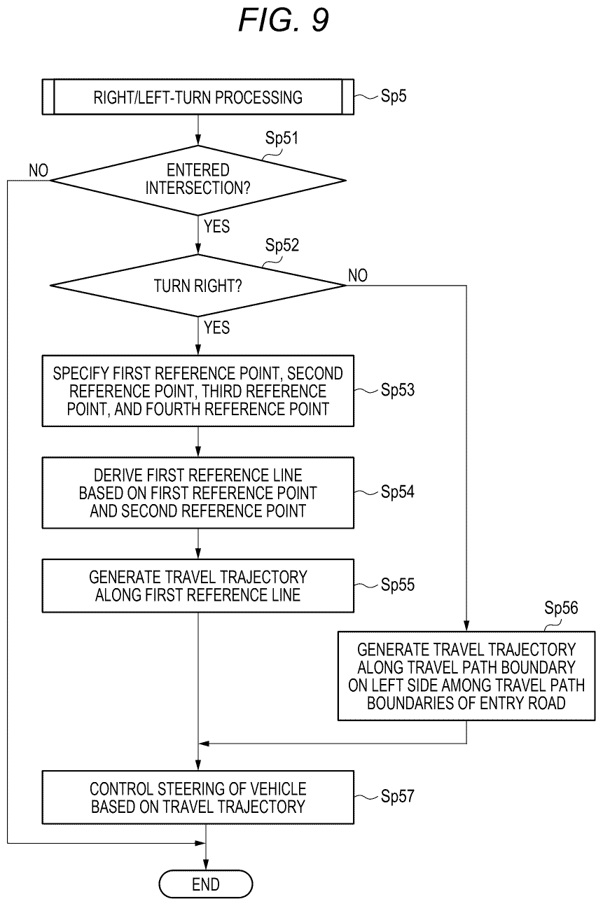

As shown in FIG. 9, in the right/left-turn processing of step Sp5, the control device 30 first determines whether the vehicle 1 has entered the intersection CP (step Sp51). When it is determined that the vehicle 1 has entered the intersection CP (step Sp51: YES), the control device 30 determines whether the vehicle 1 turns right at the intersection CP (step Sp52).

When it is determined that the vehicle 1 turns right (step Sp52: YES), the control device 30 specifies the first reference point Rp1, the second reference point Rp2, the third reference point Rp3, and the fourth reference point Rp4 (step Sp53).

Next, the control device 30 derives the first reference line RL1 based on the first reference point Rp1 and the second reference point Rp2 (step Sp54).

Next, the control device 30 generates a travel trajectory (for example, the travel trajectory Ob2 shown in FIG. 4) turning along the first reference line RL1 (step Sp55). Then, the control device 30 controls the steering of the vehicle 1 based on the travel trajectory generated by the processing of step Sp55 (step Sp57), and ends the current right/left-turn processing.

On the other hand, when it is determined that the vehicle 1 does not turn right (that is, turns left) at the intersection CP in the processing of step Sp52 (step Sp52: NO), the control device 30 generates a travel trajectory (for example, the travel trajectory Ob4 shown in FIG. 6) along a travel path boundary on a left side among the travel path boundaries of the entry road RdA (more specifically, the host lane) (step Sp56). Then, the control device 30 controls the steering of the vehicle 1 based on the travel trajectory generated by the processing of step Sp56 (step Sp57), and ends the current right/left-turn processing.

As described above, according to the control device 30, when the intersection angle θx at the intersection CP between the entry road RdA and the exit road RdE is within the first angle range and the vehicle 1 travels straight through the intersection CP, a travel trajectory passing between the first reference line RL1 derived based on the recognition result of the recognition unit 31 and the predetermined straight-travel reference point Px can be generated, and the steering of the vehicle 1 can be controlled based on the travel trajectory. Accordingly, even if no information on the intersection CP is prepared in advance, the vehicle 1 that is about to travel straight through the multi-way intersection CP at which five or more roads are connected can travel based on an appropriate travel trajectory in consideration of another vehicle (for example, another vehicle traveling in an oncoming lane) traveling through the intersection CP.

Further, according to the control device 30, when the intersection angle θx is within the second angle range and the vehicle 1 turns right at the intersection CP, a travel trajectory turning along the first reference line RL1 derived based on the recognition result of the recognition unit 31 can be generated, and the steering of the vehicle 1 can be controlled based on the travel trajectory. Accordingly, even if no information on the intersection CP is prepared in advance, the vehicle 1 that is about to turn right at the multi-way intersection CP at which five or more roads are connected can travel based on an appropriate travel trajectory with no excessively small or large turn.

Further, according to the control device 30, when the intersection angle θx is within the second angle range and the vehicle 1 turns left at the intersection CP, a travel trajectory toward the exit position PE along a travel path boundary on the left side (that is, an exit road RdE side) of the entry road RdA recognized by the recognition unit 31 can be generated, and the steering of the vehicle 1 can be controlled based on the travel trajectory. Accordingly, even if no information on the intersection CP is prepared in advance, the vehicle 1 that is about to turn left at the multi-way intersection CP at which five or more roads are connected can travel based on an appropriate travel trajectory with no excessively small or large turn.

### 5. Modification of Vehicle Control Performed by Control Device

Next, a modification of the vehicle control performed by the control device 30 will be described. In the following, portions different from the example described above will be mainly described, and the description of portions common to the example described above will be appropriately omitted or simplified.

### Modification of Travel Trajectory Generated When Vehicle Travels Straight through Intersection

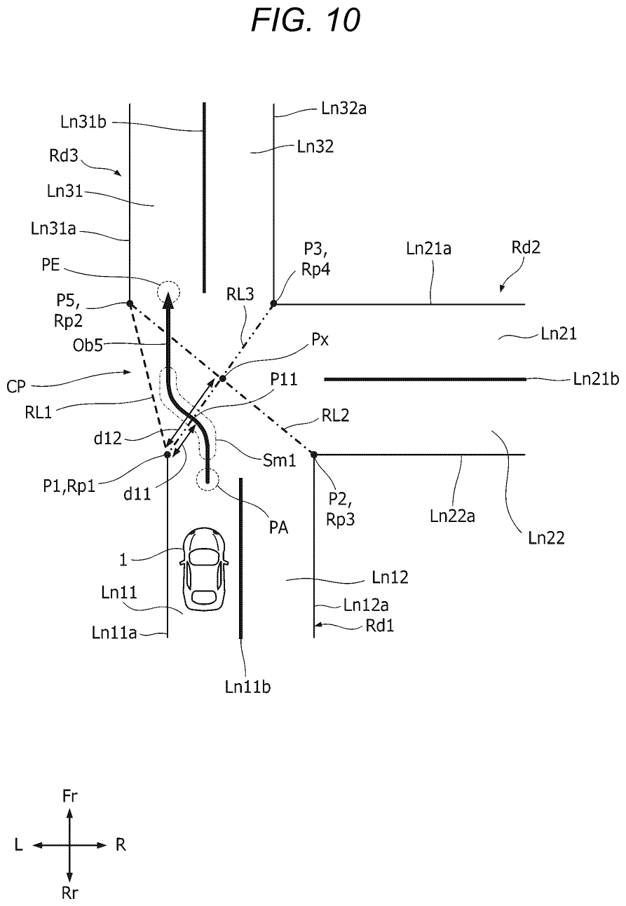

FIG. 10 is a diagram showing a modification (Modification 1) of the travel trajectory generated when the vehicle 1 travels straight through the intersection CP. In the example shown in FIG. 10, the vehicle 1 is about to travel from the road Rd1 to the road Rd3 by traveling substantially straight through the intersection CP. That is, in the present example, the entry road RdA is the road Rd1, and the exit road RdE is the road Rd3. The intersection angle θx at the intersection CP between the road Rd1 which is the entry road RdA and the road Rd3 which is the exit road RdE is an angle within the first angle range. In the present example, the exit position PE is offset to the left side (that is, one side in the vehicle width direction of the vehicle 1) relative to the entry position PA. In FIG. 10, the road Rd4, the road Rd5, and the like are not shown.

In this way, when the intersection angle θx is within the first angle range (that is, the vehicle 1 travels substantially straight through the intersection CP) and the exit position PE is offset to the left side relative to the entry position PA, the trajectory generation unit 32 may generate a travel trajectory such as a travel trajectory Ob5 shown in FIG. 10 as the travel trajectory passing between the first reference line RL1 and the straight-travel reference point Px.

Here, the travel trajectory Ob5 is a travel trajectory which passes through a first point P11 on the third reference line RL3 separated by a predetermined distance d11 from the first reference point Rp1 (here, the contact point P1) and in which the first point P11 is an inflection point, and has, for example, a portion Sm1 that is point-symmetrical relative to the first point P11. Here, the predetermined distance d11 is smaller than a distance d12 from the first reference point Rp1 to the straight-travel reference point Px.

In this way, when the vehicle 1 travels straight through the intersection CP and the exit position PE is offset to the left side relative to the entry position PA, by generating the travel trajectory Ob5 which passes through the first point P11 on the third reference line RL3 separated by the predetermined distance d11 from the first reference point Rp1 and in which the first point P11 is an inflection point, it is possible to generate the travel trajectory Ob5 that smoothly turns in the intersection CP and is directed from the entry position PA to the exit position PE while considering another vehicle traveling through the intersection CP.

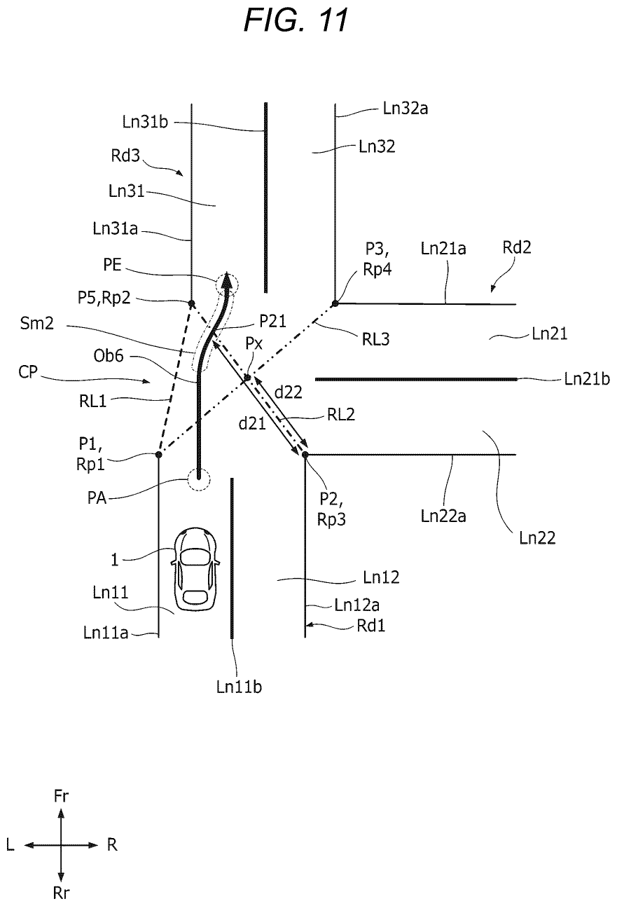

FIG. 11 is a diagram showing a modification (Modification 2) of the travel trajectory generated when the vehicle 1 travels straight through the intersection CP. Here, portions different from the example shown in FIG. 10 will be mainly described, and the description of portions common to the example shown in FIG. 10 will be appropriately omitted or simplified. In FIG. 11, the road Rd4, the road Rd5, and the like are also not shown.

In the example shown in FIG. 11, the vehicle 1 is about to travel from the road Rd1 to the road Rd3 by traveling substantially straight through the intersection CP. In the present example, the exit position PE is offset to a right side (that is, the other side in the vehicle width direction of the vehicle 1) relative to the entry position PA.

In this way, when the intersection angle θx is within the first angle range (that is, the vehicle 1 travels substantially straight through the intersection CP) and the exit position PE is offset to the right side relative to the entry position PA, the trajectory generation unit 32 may generate a travel trajectory such as a travel trajectory Ob6 shown in FIG. 11 as the travel trajectory passing between the first reference line RL1 and the straight-travel reference point Px.

Here, the travel trajectory Ob6 is a travel trajectory which passes through a second point P21 on the second reference line RL2 separated by a predetermined distance d21 from the third reference point Rp3 (here, the contact point P2) and in which the second point P21 is an inflection point, and has, for example, a portion Sm2 that is point-symmetrical relative to the second point P21. Here, the predetermined distance d21 is larger than a distance d22 from the third reference point Rp3 to the straight-travel reference point Px.

In this way, when the vehicle 1 travels straight through the intersection CP and the exit position PE is offset to the right side relative to the entry position PA, by generating the travel trajectory Ob6 which passes through the second point P21 on the second reference line RL2 separated by the predetermined distance d21 from the third reference point Rp3 and in which the second point P21 is an inflection point, it is possible to generate the travel trajectory Ob6 that smoothly turns in the intersection CP and is directed from the entry position PA to the exit position PE while considering another vehicle traveling through the intersection CP.

### Modification of Travel Trajectory Generated When Vehicle Turns Right at Intersection

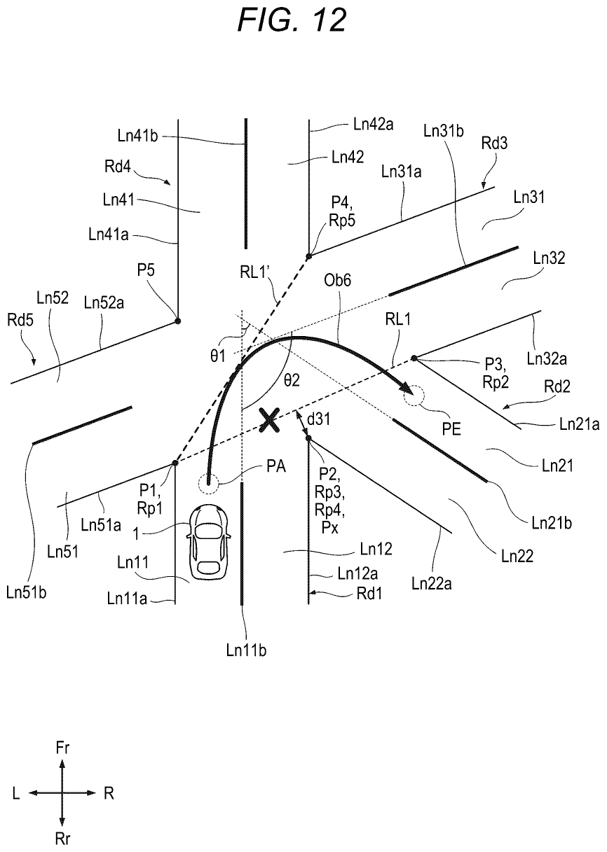

FIG. 12 is a diagram showing a modification of the travel trajectory generated when the vehicle 1 turns right at the intersection CP. In the example shown in FIG. 12, the vehicle 1 is about to travel from the road Rd1 to the road Rd2 by making a sort of U-turn to the right at the intersection CP. That is, in the present example, the entry road RdA is the road Rd1, and the exit road RdE is the road Rd2. The intersection angle θx (here, it is referred to as an intersection angle θ1) at the intersection CP between the road Rd1 which is the entry road RdA and the road Rd2 which is the exit road RdE is an angle within the second angle range.

For example, as shown in FIG. 12, when a distance d31 between the first reference line RL1 and the third reference point Rp3 (here, the contact point P2) is smaller than a vehicle width dimension of the vehicle 1, a situation in which at least a part of the vehicle 1 goes out of the road in the travel trajectory along the first reference line RL1 may occur, which is not preferable from the viewpoint of appropriate traveling of the vehicle 1.

Therefore, when the distance d31 between the first reference line RL1 and the third reference point Rp3 is equal to or greater than a threshold, the trajectory generation unit 32 may generate a travel trajectory (for example, the travel trajectory Ob2 shown in FIG. 4) turning along the first reference line RL1 as described above, and when the distance d31 is smaller than the threshold, the trajectory generation unit 32 may derive a new first reference line RL1′ passing through the first reference point Rp1 and a predetermined fifth reference point Rp5 based on the fifth reference point Rp5 and the first reference point Rp1, and generate a travel trajectory turning along the first reference line RL1′. Here, the threshold is set in advance by, for example, the manufacturer of the vehicle 1 in consideration of the vehicle width dimension of the vehicle 1.

Here, the fifth reference point Rp5 is an end point of a boundary between the intersection CP and a third road different from the entry road RdA and the exit road RdE, on one side in a width direction of the third road. Here, the third road is a road that is present on one of the left and right sides of the entry road RdA on which the exit road RdE is present at the intersection CP, and in which an intersection angle with the entry road RdA at the intersection CP is second smallest after the exit road RdE.

In the example shown in FIG. 12, since the exit road RdE is the road Rd2, the road Rd3 that is present on the right side of the entry road RdA similarly to the road Rd2 and in which the intersection angle θ2 that is the intersection angle with the entry road RdA is second smallest after the intersection angle θ1 is the third road.

Therefore, in this case, when the distance d31 is smaller than the threshold, the trajectory generation unit 32 may specify the contact point P4 as the fifth reference point Rp5, derive a virtual line segment passing through the fifth reference point Rp5 (that is, the contact point P4) and the first reference point Rp1 (that is, the contact point P1) as the new first reference line RL1′, and generate the travel trajectory Ob6 turning along the first reference line RL1′. Accordingly, when it is considered that it is difficult for the vehicle 1 to appropriately travel on the travel trajectory along the first reference line RL1 obtained based on the first reference point Rp1 and the second reference point Rp2, the vehicle 1 can travel on the travel trajectory along the new first reference line RL1′ obtained based on the first reference point Rp1 and the fifth reference point Rp5. Therefore, the vehicle 1 can travel based on an appropriate travel trajectory in consideration of the intersection angle θx at the intersection CP between the entry road RdA and the exit road RdE.

### Modification of Travel Trajectory Generated When Vehicle Turns Left at Intersection

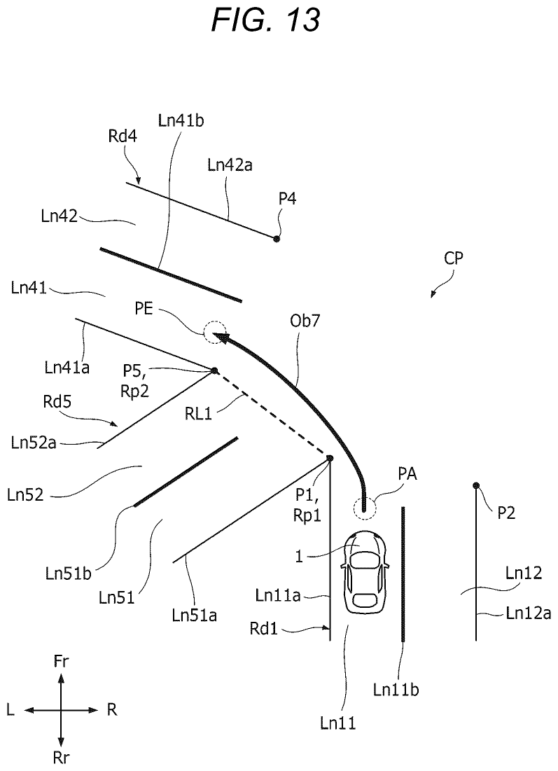

FIG. 13 is a diagram showing a modification of the travel trajectory generated when the vehicle 1 turns left at the intersection CP. In the example shown in FIG. 13, the vehicle 1 is about to turn left at the intersection CP to travel from the road Rd1 to the second road Rd2. That is, in the present example, the entry road RdA is the road Rd1, and the exit road RdE is the road Rd4. The intersection angle θx at the intersection CP between the road Rd1 which is the entry road RdA and the road Rd4 which is the exit road RdE is an angle within the second angle range. In FIG. 13, the road Rd2, the road Rd3, and the like are not shown.

As shown in FIG. 13, when another road (the road Rd5 in the example shown in FIG. 13) is present which is closer to the entry position PA than the exit road RdE is and on which a left turn can be made, the trajectory generation unit 32 may generate a travel trajectory Ob7 enabling the vehicle 1 to travel along the travel path boundary Ln11a on the left side of the lane Ln11 that is the host lane (that is, on a side of the road Rd2 that is the exit road RdE) and then travel along the first reference line RL1, thereby traveling from the entry position PA to the exit position PE. In this way, even when another road is present that is nearer than the exit road RdE is and on which a left turn can be made, the travel trajectory Ob7 enabling the vehicle 1 to appropriately turn left so as to travel to the exit road RdE can be generated.

### Another Modification of Travel Trajectory Generated When Vehicle Travels Straight Through Intersection

Next, another modification of the travel trajectory generated when the vehicle 1 travels straight through the intersection CP will be described. When the vehicle 1 travels straight through the intersection CP (more specifically, for example, when the intersection angle θx is within the first angle range), the control device 30 may generate a travel trajectory as to be described below as the travel trajectory of the vehicle 1.

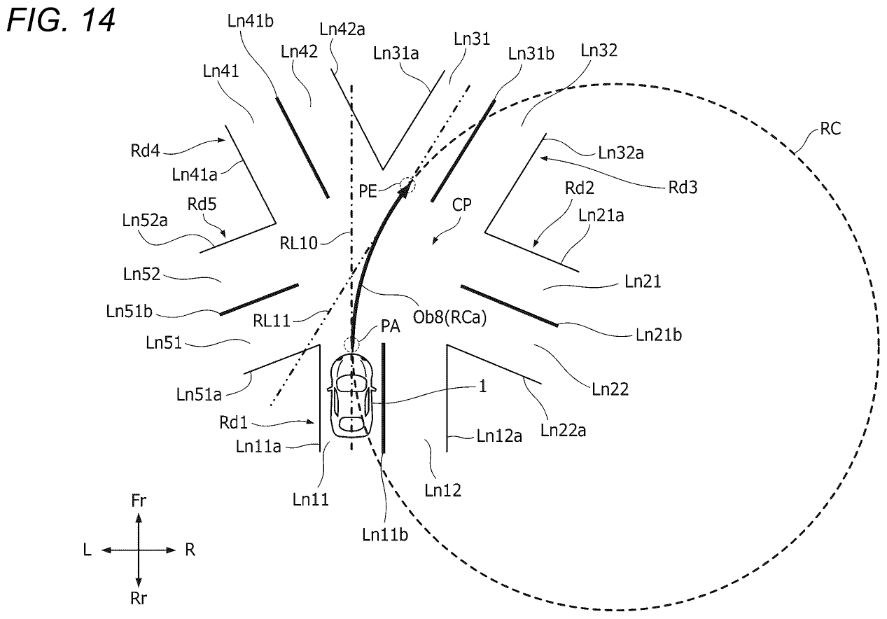

FIG. 14 is a diagram showing another modification of the travel trajectory generated when the vehicle 1 travels straight through the intersection CP. In the example shown in FIG. 14, the vehicle 1 is about to travel from the road Rd1 to the road Rd3 by traveling substantially straight through the intersection CP. That is, in the present example, the entry road RdA is the road Rd1, and the exit road RdE is the road Rd3.

As shown in FIG. 14, in the present example, the trajectory generation unit 32 (that is, the control device 30) derives, based on the recognition result of the recognition unit 31, an entry direction line RL10, which is a line segment passing through the entry position PA (for example, center coordinates of the entry position PA) and extending along the entry road RdA (here, the road Rd1) including the entry position PA. As an example, the trajectory generation unit 32 derives, as the entry direction line RL10, a line segment that is parallel to the travel path boundaries (here, the travel path boundaries Ln11a and Ln11b) of the entry road RdA (here, the road Rd1) and extends toward the intersection CP while passing through the entry position PA. As another example, the trajectory generation unit 32 may derive the entry direction line RL10 using information such as a link of the entry road RdA connected to the node of the intersection CP instead of the travel path boundaries of the entry road RdA.

In the present example, the trajectory generation unit 32 derives, based on the recognition result of the recognition unit 31, an exit direction line RL11, which is a line segment passing through the exit position PE (for example, center coordinates of the exit position PE) and extending along the exit road RdE (here, the road Rd3) including the exit position PE. As an example, the trajectory generation unit 32 derives, as the exit direction line RL11, a line segment that is parallel to the travel path boundaries (here, the travel path boundaries Ln31a and Ln31b) of the exit road RdE (here, the road Rd3) and extends toward the intersection CP while passing through the exit position PE. As another example, the trajectory generation unit 32 may derive the exit direction line RL11 using information such as a link of the exit road RdE connected to the node of the intersection CP instead of the travel path boundaries of the exit road RdE.

In the present example, the trajectory generation unit 32 derives a reference circle RC having the entry direction line RL10 and the exit direction line RL11 as tangents and having the entry position PA (for example, the center coordinates of the entry position PA) and the exit position PE (for example, the center coordinates of the exit position PE) as points of tangency, based on the entry position PA, the exit position PE, the entry direction line RL10, and the exit direction line RL11. The trajectory generation unit 32 can geometrically obtain the reference circle RC from the entry position PA, the exit position PE, the entry direction line RL10, and the exit direction line RL11.

In the present example, the trajectory generation unit 32 generates an arc RCa between the entry position PA and the exit position PE in the derived reference circle RC as a travel trajectory Ob8 when the vehicle 1 travels straight through the intersection CP. Accordingly, as shown in FIG. 14, even if no information on the intersection CP is prepared in advance, the control device 30 can generate an appropriate travel trajectory Ob8 in consideration of another vehicle traveling through the intersection CP (for example, another vehicle traveling in an oncoming lane).

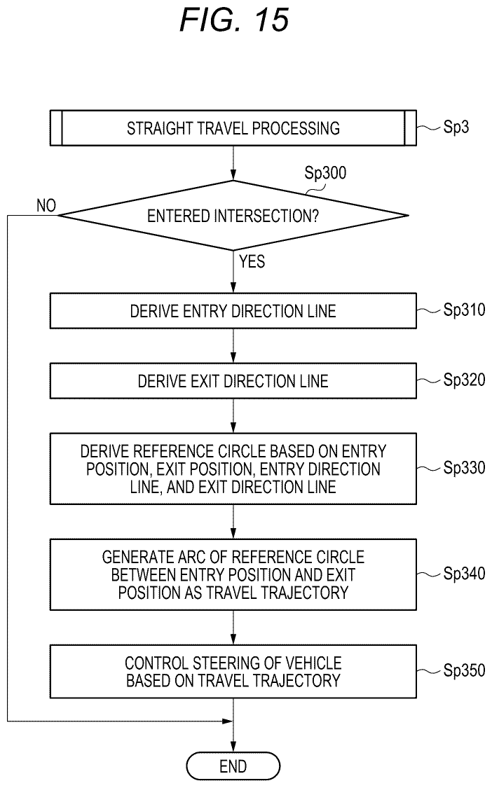

FIG. 15 is a flowchart showing another example of the processing procedure of the straight travel processing in step Sp3 performed by the control device 30. As shown in FIG. 15, in the straight travel processing of step Sp3, the control device 30 of the present example first determines whether the vehicle 1 has entered the intersection CP (step Sp300).

When it is determined that the vehicle 1 has entered the intersection CP (step Sp300: YES), the control device 30 derives the entry direction line RL10 (step Sp310) and derives the exit direction line RL11 (step Sp320) based on the recognition result of the recognition unit 31 and the like.

Next, the control device 30 derives the reference circle RC based on the entry position PA, the exit position PE, the entry direction line RL10, and the exit direction line RL11 (step Sp330). Then, the control device 30 generates the arc RCa between the entry position PA and the exit position PE in the derived reference circle RC as the travel trajectory of the vehicle 1 (for example, the travel trajectory Ob8 shown in FIG. 14) (step Sp340).

Next, the control device 30 controls the steering of the vehicle 1 based on the travel trajectory generated by the processing of step Sp340 (step Sp350), and ends the current straight travel processing.

As described above, when the intersection CP present in the traveling direction of the vehicle 1 is a five-way road and the vehicle 1 travels straight through the intersection CP, the control device 30 (for example, the trajectory generation unit 32) derives the entry direction line RL10 and the exit direction line RL11 based on the recognition result of the recognition unit 31 and the like. Then, the control device 30 derives the reference circle RC based on the entry position PA, the exit position PE, the entry direction line RL10, and the exit direction line RL11, and generates the arc RCa between the entry position PA and the exit position PE in the reference circle RC as the travel trajectory of the vehicle 1. Accordingly, even if no information on the intersection CP is prepared in advance, the control device 30 can generate an appropriate travel trajectory in consideration of another vehicle traveling through the intersection CP (for example, another vehicle traveling in an oncoming lane) as the travel trajectory when the vehicle 1 travels straight through the intersection CP. Therefore, the vehicle 1 appropriately traveling in the intersection CP is enabled with a simple configuration. In addition, it is possible to improve traffic safety and contribute to development of a sustainable transportation system.

As described above, according to the control device 30 of the present embodiment, the vehicle 1 appropriately traveling in the intersection CP is enabled with a simple configuration. In addition, it is possible to improve traffic safety and contribute to the development of the sustainable transportation system.

The control method described in the present embodiment can be implemented by a computer executing a program (control program) prepared in advance. The control program is stored in, for example, a computer-readable storage medium and executed by being read from the storage medium. In addition, the control program may be provided in a form stored in a non-volatile (non-transitory) storage medium such as a flash memory, or may be provided via a network such as the Internet. In the present embodiment, a computer that executes the present control program is the control device 30 (for example, the processor of the control device 30), but is not limited thereto. The computer that executes the control program may be provided in the vehicle 1 or may be provided in the external device 2 that can communicate with the vehicle 1.

Although an embodiment of the present disclosure has been described above, it goes without saying that the present disclosure is not limited to the embodiment. It is apparent that those skilled in the art can conceive of various modifications and alterations within the scope described in the claims, and it is understood that such modifications and alterations naturally fall within the technical scope of the present disclosure.

For example, in the embodiment described above, an example in which the intersection CP present in the traveling direction of the vehicle 1 is a five-way road has been described, but the intersection CP is not limited to the five-way road, and may be a multi-way road with six or more ways.

In the present description and the like, at least the following matters are described. Although corresponding constituent elements and the like in the above embodiment are shown in parentheses, the present disclosure is not limited thereto.

(1) A vehicle control device (control device 30) for controlling a vehicle (vehicle 1), including:
a recognition unit (recognition unit 31) configured to recognize a surrounding situation of the vehicle;
a trajectory generation unit (trajectory generation unit 32) configured to generate, in response to an intersection (intersection CP) present in a traveling direction of the vehicle being recognized by the recognition unit, a travel trajectory (travel trajectory Ob1 to Ob6) from an entry position (entry position PA) to an exit position (exit position PE) of the vehicle at the intersection; and
a travel control unit (travel control unit 33) configured to cause the vehicle to travel based on the travel trajectory generated by the trajectory generation unit, in which
the trajectory generation unit is configured to, in a case where the intersection is a multi-way intersection at which five or more roads or more are connected, and an intersection angle (intersection angle θx) at the intersection between a first road (entry rode RdA) including the entry position and a second road (exit rode RdE) including the exit position is within a first angle range including 180 degrees,
   specify, based on a recognition result of the recognition unit, a first reference point (first reference point Rp1) which is an end point of a boundary between the first road and the intersection on one side in a width direction of the first road, and a second reference point (second reference point Rp2) which is an end point of a boundary between the second road and the intersection on one side in a width direction of the second road,
   derive, based on the first reference point and the second reference point, a first reference line (first reference line RL1) which is a line segment passing through the first reference point and the second reference point, and
   generate the travel trajectory based on the first reference line.

According to (1), even if no information on the intersection is prepared in advance, the vehicle that is about to straight travel through the multi-way intersection at which five or more roads are connected can travel based on an appropriate travel trajectory. Accordingly, it is possible to provide a vehicle control device that enables the vehicle to appropriately travel in the intersection with a simple configuration. In addition, it is possible to improve traffic safety and contribute to development of a sustainable transportation system.

(2) The vehicle control device according to (1), in which
the trajectory generation unit generates the travel trajectory passing between the first reference line and a predetermined straight-travel reference point (straight-travel reference point Px) at the intersection.

According to (2), a vehicle that is about to travel straight through the multi-way intersection can travel based on an appropriate travel trajectory in consideration of another vehicle traveling through the intersection.

(3) The vehicle control device according to (2), in which
the trajectory generation unit
   specifies, based on the recognition result of the recognition unit, a third reference point (third reference point Rp3) which is an end point of the boundary between the first road and the intersection on the other side in the width direction of the first road, and a fourth reference point (fourth reference point Rp4) which is an end point of the boundary between the second road and the intersection on the other side in the width direction of the second road,
   derives, based on the second reference point and the third reference point, a second reference line (second reference line RL2) which is a line segment passing through the second reference point and the third reference point, and derives, based on the first reference point and the fourth reference point, a third reference line (third reference line RL3) that is a line segment passing through the first reference point and the fourth reference point, and
   sets an intersection point between the second reference line and the third reference line as the straight-travel reference point.

According to (3), an appropriate straight-travel reference point can be set based on the recognition result of the recognition unit.

(4) The vehicle control device according to (3), in which
in a case where the exit position is offset to one side in a vehicle width direction of the vehicle relative to the entry position, the trajectory generation unit generates the travel trajectory which passes through a first point (first point P11) on the third reference line separated from the first reference point by a predetermined distance (predetermined distance d11) and in which the first point is an inflection point.

According to (4), it is possible to generate a travel trajectory that smoothly turns in the intersection and is directed to the exit position while considering another vehicle traveling through the intersection.

(5) The vehicle control device according to (4), in which
the travel trajectory in which the first point is the inflection point has a portion (portion Sm1) that is point-symmetrical relative to the first point.

According to (5), it is possible to generate a travel trajectory that smoothly turns in the intersection and is directed to the exit position while considering another vehicle traveling through the intersection.

(6) The vehicle control device according to (2), in which
the vehicle control device is configured to refer to map information (map information database 24) including road network information indicating each road by a combination of nodes and a link connecting the nodes, and
the trajectory generation unit sets a point indicated by one of the nodes corresponding to the intersection in the map information as the straight-travel reference point.

According to (6), an appropriate straight-travel reference point can be set based on the map information including general road network information.

(7) The vehicle control device according to (2), in which
in a case where a road marking (right/left-turn road marking Rm) designating a portion for the vehicle to pass when turning right or left at the intersection is recognized by the recognition unit, the trajectory generation unit sets a point where the road marking is provided as the straight-travel reference point.

According to (7), it is possible to set an appropriate straight-travel reference point in consideration of the point at which the road marking designating the portion through which the vehicle is to pass when turning right or left at the intersection is provided.

(8) The vehicle control device according to (2), in which,
in a case where the intersection is the multi-way intersection and the intersection angle is within a second angle range smaller than the first angle range, the trajectory generation unit
   specifies the first reference point and the second reference point based on the recognition result of the recognition unit,
   derives the first reference line based on the first reference point and the second reference point, and
   generates the travel trajectory turning along the first reference line based on the first reference line.

According to (8), even if no information on the intersection is prepared in advance, the vehicle that is about to turn left or right at the multi-way intersection at which five or more roads are connected can travel based on an appropriate travel trajectory.

(9) The vehicle control device according to (8), in which,
in a case where the intersection is the multi-way intersection and the intersection angle is within the second angle range, the trajectory generation unit
   generates the travel trajectory turning along the first reference line in a case where a distance (distance d31) between a third reference point which is an end point of the boundary between the first road and the intersection on the other side in the width direction of the first road and the first reference line which is based on the first reference point and the second reference point is equal to or greater than a threshold, and
   derives, based on the first reference point and a fifth reference point (fifth reference point Rp5) which is an end point of a boundary, between the intersection and a third road different from the first road and the second road, on one side in a width direction of the third road, a new first reference line (first reference line RL1′) passing through the first reference point and the fifth reference point, in a case where the distance is smaller than the threshold, and
   generates, based on the new first reference line, the travel trajectory turning along the first reference line,
the second road is a road present on one of left and right sides relative to the first road at the intersection, and
the third road is a road that is present on one of the left and right sides relative to the first road at the intersection and in which an intersection angle with the first road at the intersection is second smallest after the second road.

According to (9), when it is considered that it is difficult for the vehicle to appropriately travel on the travel trajectory along the first reference line which is based on the first reference point and the second reference point, the vehicle can travel on the travel trajectory along the new first reference line which is based on the first reference point and the fifth reference point. Accordingly, the vehicle can travel based on an appropriate travel trajectory in consideration of the intersection angle at the intersection between the first road and the second road.

(10) The vehicle control device according to (8), in which
the trajectory generation unit does not perform the generation of the travel trajectory that is based on the first reference line, in a case where the intersection angle is smaller than a lower limit value of the second angle range.

According to (10), when the intersection angle is smaller than the lower limit value of the second angle range (for example, when the vehicle makes a U-turn at the intersection), the generation of the travel trajectory based on the first reference line is not performed, and thus occurrence of an unintended problem due to the traveling of the vehicle based on the travel trajectory can be prevented.

(11) The vehicle control device according to any one of (1) to (10), in which
the trajectory generation unit specifies the intersection angle at the intersection between the first road and the second road based on the recognition result of the recognition unit.

According to (11), even if no information on the intersection is prepared in advance, the intersection angle at the intersection between the first road and the second road can be specified based on the recognition result of the recognition unit.

(12) The vehicle control device according to any one of (1) to (10), in which
the vehicle control device is configured to refer to map information including road network information indicating each road by a combination of nodes and a link connecting the nodes, and
the trajectory generation unit specifies the intersection angle at the intersection between the first road and the second road based on the map information.

According to (12), the intersection angle at the intersection between the first road and the second road can be specified based on the map information including general road network information.

(13) A control method includsing causing a computer (control device 30), for controlling a vehicle (vehicle 1), to perform processing including:
recognizing (step Sp0) a surrounding situation of the vehicle;
generating (step Sp3, step Sp5), in response to an intersection present in a traveling direction of the vehicle being recognized, a travel trajectory from an entry position to an exit position of the vehicle at the intersection; and
causing the vehicle to travel (step Sp39, step Sp57) based on the generated travel trajectory, in which
in the generating of the travel trajectory, in a case where the intersection is a multi-way intersection at which five or more roads are connected, and an intersection angle at the intersection between a first road including the entry position and a second road including the exit position is within a first angle range including 180 degrees,
   based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified (step Sp31),
   based on the first reference point and the second reference point, a first reference line which is a line segment passing through the first reference point and the second reference point is derived (step Sp32), and
   the travel trajectory is generated (step Sp38) based on the first reference line.

According to (13), even if no information on the intersection is prepared in advance, the vehicle that is about to straight travel through the multi-way intersection at which five or more roads are connected can travel based on an appropriate travel trajectory. Therefore, the vehicle appropriately traveling in the intersection is enabled with a simple configuration. In addition, it is possible to improve traffic safety and contribute to the development of the sustainable transportation system.

(14) A non-transitory computer-readable storage medium storing a control program causing a computer (control device 30), for controlling a vehicle (vehicle 1), to execute processing including:
recognizing (step Sp0) a surrounding situation of the vehicle;
generating (step Sp3, step Sp5), in response to an intersection present in a traveling direction of the vehicle being recognized, a travel trajectory from an entry position to an exit position of the vehicle at the intersection; and
causing the vehicle to travel (step Sp39, step Sp57) based on the generated travel trajectory, in which
in the generating of the travel trajectory, in a case where the intersection is a multi-way intersection at which five or more roads are connected, and an intersection angle at the intersection between a first road including the entry position and a second road including the exit position is within a first angle range including 180 degrees,
   based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified (step Sp31),
   based on the first reference point and the second reference point, a first reference line which is a line segment passing through the first reference point and the second reference point is derived (step Sp32), and
   the travel trajectory is generated (step Sp38) based on the first reference line.

According to (14), even if no information on the intersection is prepared in advance, the vehicle that is about to straight travel through the multi-way intersection at which five or more roads are connected can travel based on an appropriate travel trajectory. Therefore, the vehicle appropriately traveling in the intersection is enabled with a simple configuration. In addition, it is possible to improve traffic safety and contribute to the development of the sustainable transportation system.

(15) A vehicle control device (control device 30) for controlling a vehicle (vehicle 1), including:
a recognition unit (recognition unit 31) configured to recognize a surrounding situation of the vehicle;
a trajectory generation unit (trajectory generation unit 32) configured to generate, in response to an intersection (intersection CP) present in a traveling direction of the vehicle being recognized by the recognition unit, a travel trajectory (travel trajectory Ob8) from an entry position (entry position PA) to an exit position (exit position PE) of the vehicle at the intersection; and
a travel control unit (travel control unit 33) configured to cause the vehicle to travel based on the travel trajectory generated by the trajectory generation unit, in which
the trajectory generation unit is configured to, in a case where the intersection is a multi-way intersection at which five or more roads are connected, and the vehicle straight travels through the intersection from a first road (entry rode RdA) including the entry position to a second road (exit rode RdE) including the exit position,
   derive, based on a recognition result of the recognition unit, an entry direction line (entry direction line RL10) which is a line segment passing through the entry position and extending along the first road, and an exit direction line (exit direction line RL11) which is a line segment passing through the exit position and extending along the second road,
   derive, based on the entry position, the exit position, the entry direction line, and the exit direction line, a reference circle (reference circle RC) having the entry direction line and the exit direction line as tangents and having the entry position and the exit position as points of tangency, and
   generate an arc (arc RCa) of the reference circle between the entry position and the exit position as the travel trajectory.

According to (15), even if no information on the intersection is prepared in advance, an appropriate travel trajectory in consideration of another vehicle traveling through the intersection (for example, another vehicle traveling in an oncoming lane) can be generated as the travel trajectory when the vehicle travels straight through the intersection. Accordingly, it is possible to provide a vehicle control device that enables the vehicle to appropriately travel in the intersection with a simple configuration. In addition, it is possible to improve traffic safety and contribute to the development of the sustainable transportation system.

(16) A control method including causing a computer (control device 30), for controlling a vehicle (vehicle 1), to perform processing including:
recognizing (step Sp0) a surrounding situation of the vehicle;
generating (step Sp340), in response to an intersection (intersection CP) present in a traveling direction of the vehicle being recognized, a travel trajectory (travel trajectory Ob8) from an entry position (entry position PA) to an exit position (exit position PE) of the vehicle at the intersection; and
causing the vehicle to travel (step Sp350) based on the generated travel trajectory, in which
in the generating of the travel trajectory, in a case where the intersection is a multi-way intersection at which five or more roads are connected, and the vehicle straight travels through the intersection from a first road (entry rode RdA) including the entry position to a second road (exit rode RdE) including the exit position,
   based on a recognition result of the surrounding situation, an entry direction line (entry direction line RL10) which is a line segment passing through the entry position and extending along the first road, and an exit direction line (exit direction line RL11) which is a line segment passing through the exit position and extending along the second road are derived (step SP310, step Sp320),
   based on the entry position, the exit position, the entry direction line, and the exit direction line, a reference circle (reference circle RC) having the entry direction line and the exit direction line as tangents and having the entry position and the exit position as points of tangency is derived (step Sp330), and
   an arc (arc RCa) of the reference circle between the entry position and the exit position is generated (step Sp340) as the travel trajectory.

According to (16), even if no information on the intersection is prepared in advance, an appropriate travel trajectory in consideration of another vehicle traveling through the intersection (for example, another vehicle traveling in an oncoming lane) can be generated as the travel trajectory when the vehicle travels straight through the intersection. Therefore, the vehicle appropriately traveling in the intersection is enabled with a simple configuration. In addition, it is possible to improve traffic safety and contribute to the development of the sustainable transportation system.

(17) A non-transitory computer-readable storage medium storing a control program causing a computer (control device 30), for controlling a vehicle (vehicle 1), to execute processing including:
recognizing (step Sp0) a surrounding situation of the vehicle;
generating (step Sp340), in response to an intersection (intersection CP) present in a traveling direction of the vehicle being recognized, a travel trajectory (travel trajectory Ob8) from an entry position (entry position PA) to an exit position (exit position PE) of the vehicle at the intersection; and
causing the vehicle to travel (step Sp350) based on the generated travel trajectory, in which
in the generating of the travel trajectory, in a case where the intersection is a multi-way intersection at which five or more roads are connected, and the vehicle straight travels through the intersection from a first road (entry rode RdA) including the entry position to a second road (exit rode RdE) including the exit position,
   based on a recognition result of the surrounding situation, an entry direction line (entry direction line RL10) which is a line segment passing through the entry position and extending along the first road, and an exit direction line (exit direction line RL11) which is a line segment passing through the exit position and extending along the second road are derived (step Sp310, step Sp320),
   based on the entry position, the exit position, the entry direction line, and the exit direction line, a reference circle (reference circle RC) having the entry direction line and the exit direction line as tangents and having the entry position and the exit position as points of tangency is derived (step Sp330), and
   an arc (arc RCa) of the reference circle between the entry position and the exit position is generated as the travel trajectory.

According to (17), even if no information on the intersection is prepared in advance, an appropriate travel trajectory in consideration of another vehicle traveling through the intersection (for example, another vehicle traveling in an oncoming lane) can be generated as the travel trajectory when the vehicle travels straight through the intersection. Therefore, the vehicle appropriately traveling in the intersection is enabled with a simple configuration. In addition, it is possible to improve traffic safety and contribute to the development of the sustainable transportation system.

What is claimed is:

1. A vehicle control device for controlling a vehicle, comprising:
a recognition unit configured to recognize a surrounding situation of the vehicle;
a trajectory generation unit configured to generate, in response to an intersection present in a traveling direction of the vehicle being recognized by the recognition unit, a travel trajectory from an entry position to an exit position of the vehicle at the intersection; and
a travel control unit configured to cause the vehicle to travel based on the travel trajectory generated by the trajectory generation unit, wherein
the trajectory generation unit is configured to, in a case where the intersection is a multi-way intersection at which five or more roads or more are connected, and an intersection angle at the intersection between a first road including the entry position and a second road including the exit position is within a first angle range including 180 degrees,
specify, based on a recognition result of the recognition unit, a first reference point which is an end point of a boundary between the first road and the intersection on one side in a width direction of the first road, and a second reference point which is an end point of a boundary between the second road and the intersection on one side in a width direction of the second road,
derive, based on the first reference point and the second reference point, a first reference line which is a line segment passing through the first reference point and the second reference point, and
generate the travel trajectory based on the first reference line.

2. The vehicle control device according to claim 1, wherein
the trajectory generation unit generates the travel trajectory passing between the first reference line and a predetermined straight-travel reference point at the intersection.

3. The vehicle control device according to claim 2, wherein
the trajectory generation unit
specifies, based on the recognition result of the recognition unit, a third reference point which is an end point of the boundary between the first road and the intersection on the other side in the width direction of the first road, and a fourth reference point which is an end point of the boundary between the second road and the intersection on the other side in the width direction of the second road,
derives, based on the second reference point and the third reference point, a second reference line which is a line segment passing through the second reference point and the third reference point, and derives, based on the first reference point and the fourth reference point, a third reference line that is a line segment passing through the first reference point and the fourth reference point, and
sets an intersection point between the second reference line and the third reference line as the straight-travel reference point.

4. The vehicle control device according to claim 3, wherein
in a case where the exit position is offset to one side in a vehicle width direction of the vehicle relative to the entry position, the trajectory generation unit generates the travel trajectory which passes through a first point on the third reference line separated from the first reference point by a predetermined distance and in which the first point is an inflection point.

5. The vehicle control device according to claim 4, wherein
the travel trajectory in which the first point is the inflection point has a portion that is point-symmetrical relative to the first point.

6. The vehicle control device according to claim 2, wherein
the vehicle control device is configured to refer to map information including road network information indicating each road by a combination of nodes and a link connecting the nodes, and
the trajectory generation unit sets a point indicated by one of the nodes corresponding to the intersection in the map information as the straight-travel reference point.

7. The vehicle control device according to claim 2, wherein
in a case where a road marking designating a portion for the vehicle to pass when turning right or left at the intersection is recognized by the recognition unit, the trajectory generation unit sets a point where the road marking is provided as the straight-travel reference point.

8. The vehicle control device according to claim 2, wherein,
in a case where the intersection is the multi-way intersection and the intersection angle is within a second angle range smaller than the first angle range, the trajectory generation unit
specifies the first reference point and the second reference point based on the recognition result of the recognition unit,
derives the first reference line based on the first reference point and the second reference point, and
generates the travel trajectory turning along the first reference line based on the first reference line.

9. The vehicle control device according to claim 8, wherein,
in a case where the intersection is the multi-way intersection and the intersection angle is within the second angle range, the trajectory generation unit
generates the travel trajectory turning along the first reference line in a case where a distance between a third reference point which is an end point of the boundary between the first road and the intersection on the other side in the width direction of the first road and the first reference line which is based on the first reference point and the second reference point is equal to or greater than a threshold, and
derives, based on the first reference point and a fifth reference point which is an end point of a boundary, between the intersection and a third road different from the first road and the second road, on one side in a width direction of the third road, a new first reference line passing through the first reference point and the fifth reference point, in a case where the distance is smaller than the threshold, and
generates, based on the new first reference line, the travel trajectory turning along the first reference line,
the second road is a road present on one of left and right sides relative to the first road at the intersection, and
the third road is a road that is present on one of the left and right sides relative to the first road at the intersection and in which an intersection angle with the first road at the intersection is second smallest after the second road.

10. The vehicle control device according to claim 8, wherein
the trajectory generation unit does not perform the generation of the travel trajectory that is based on the first reference line, in a case where the intersection angle is smaller than a lower limit value of the second angle range.

11. The vehicle control device according to claim 1, wherein
the trajectory generation unit specifies the intersection angle at the intersection between the first road and the second road based on the recognition result of the recognition unit.

12. The vehicle control device according to claim 1, wherein
the vehicle control device is configured to refer to map information including road network information indicating each road by a combination of nodes and a link connecting the nodes, and
the trajectory generation unit specifies the intersection angle at the intersection between the first road and the second road based on the map information.

13. A control method comprising causing a computer, for controlling a vehicle, to perform processing comprising:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, wherein
in the generating of the travel trajectory, in a case where the intersection is a multi-way intersection at which five or more roads are connected, and an intersection angle at the intersection between a first road including the entry position and a second road including the exit position is within a first angle range including 180 degrees,
based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified,
based on the first reference point and the second reference point, a first reference line which is a line segment passing through the first reference point and the second reference point is derived, and
the travel trajectory is generated based on the first reference line.

14. A non-transitory computer-readable storage medium storing a control program causing a computer, for controlling a vehicle, to execute processing comprising:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, wherein
in the generating of the travel trajectory, in a case where the intersection is a multi-way intersection at which five or more roads are connected, and an intersection angle at the intersection between a first road including the entry position and a second road including the exit position is within a first angle range including 180 degrees,
based on a recognition result of the surrounding situation, a first reference point which is an end point of a boundary between the first road and the intersection on one side in a width direction of the first road, and a second reference point which is an end point of a boundary between the second road and the intersection on one side in a width direction of the second road are specified,
based on the first reference point and the second reference point, a first reference line which is a line segment passing through the first reference point and the second reference point is derived, and
the travel trajectory is generated based on the first reference line.

15. A vehicle control device for controlling a vehicle, comprising:
a recognition unit configured to recognize a surrounding situation of the vehicle;
a trajectory generation unit configured to generate, in response to an intersection present in a traveling direction of the vehicle being recognized by the recognition unit, a travel trajectory from an entry position to an exit position of the vehicle at the intersection; and
a travel control unit configured to cause the vehicle to travel based on the travel trajectory generated by the trajectory generation unit, wherein
the trajectory generation unit is configured to, in a case where the intersection is a multi-way intersection at which five or more roads are connected, and the vehicle straight travels through the intersection from a first road including the entry position to a second road including the exit position,
derive, based on a recognition result of the recognition unit, an entry direction line which is a line segment passing through the entry position and extending along the first road, and an exit direction line which is a line segment passing through the exit position and extending along the second road,
derive, based on the entry position, the exit position, the entry direction line, and the exit direction line, a reference circle having the entry direction line and the exit direction line as tangents and having the entry position and the exit position as points of tangency, and
generate an arc of the reference circle between the entry position and the exit position as the travel trajectory.

16. A control method comprising causing a computer, for controlling a vehicle, to perform processing comprising:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, wherein
in the generating of the travel trajectory, in a case where the intersection is a multi-way intersection at which five or more roads are connected, and the vehicle straight travels through the intersection from a first road including the entry position to a second road including the exit position,
based on a recognition result of the surrounding situation, an entry direction line which is a line segment passing through the entry position and extending along the first road, and an exit direction line which is a line segment passing through the exit position and extending along the second road are derived,
based on the entry position, the exit position, the entry direction line, and the exit direction line, a reference circle having the entry direction line and the exit direction line as tangents and having the entry position and the exit position as points of tangency is derived, and
an arc of the reference circle between the entry position and the exit position is generated as the travel trajectory.

17. A non-transitory computer-readable storage medium storing a control program causing a computer, for controlling a vehicle, to execute processing comprising:
recognizing a surrounding situation of the vehicle;
generating, in response to an intersection present in a traveling direction of the vehicle being recognized, a travel trajectory from an entry position to an exit position of the vehicle at the intersection; and
causing the vehicle to travel based on the generated travel trajectory, wherein
in the generating of the travel trajectory, in a case where the intersection is a multi-way intersection at which five or more roads are connected, and the vehicle straight travels through the intersection from a first road including the entry position to a second road including the exit position,
based on a recognition result of the surrounding situation, an entry direction line which is a line segment passing through the entry position and extending along the first road, and an exit direction line which is a line segment passing through the exit position and extending along the second road are derived,
based on the entry position, the exit position, the entry direction line, and the exit direction line, a reference circle having the entry direction line and the exit direction line as tangents and having the entry position and the exit position as points of tangency is derived, and
an arc of the reference circle between the entry position and the exit position is generated as the travel trajectory.
